(19) United States
(12) Patent Application Publication
(10) Pub. No.: US 2016/0113064 A1
(43) Pub. Date: Apr. 21, 2016

(54) SYSTEMS AND DEVICES FOR PRODUCING HEAT FOR WEARABLE ARTICLES OF CLOTHING

(71) Applicant: Fownes Brothers & Co., Inc., New York, NY (US)

(72) Inventors: Thomas S. Gluckman, New York, NY (US); Even J. Dunlop, New York, NY (US); Jeffrey E. Baker, Saint Johnsville, NY (US); Timothy J. Baker, Gloversville, NY (US)

(73) Assignee: FOWNES BROTHERS & CO., INC., New York, NY (US)

(21) Appl. No.: 14/807,716

(22) Filed: Jul. 23, 2015

Related U.S. Application Data
(60) Provisional application No. 62/064,741, filed on Oct. 16, 2014.

(51) Int. Cl. H05B 3/34; A41D 19/015; H05B 3/06

(52) U.S. Cl. CPC H05B 3/342; H05B 3/06; A41D 19/01535

(57) ABSTRACT

Systems and devices for producing heat for wearable articles of clothing are generally described herein. In some embodiments, a system for providing heat to an individual may include a first wearable article, a second wearable article, and a micro-generator. The first wearable article may include a first heating element integrated into the first wearable article and a first connector. The second wearable article may include a second heating element integrated into the second wearable article and a second connector. The micro-generator, in some embodiments, may be removably attachable to at least one of the first connector of the first wearable article and the second connector of the second wearable article.

### CROSS-REFERENCE TO RELATED APPLICATIONS

This application claims the benefit of U.S. Provisional Patent Application No. 62/064,741, filed Oct. 16, 2014, the disclosure of which is incorporated herein by reference in its entirety.

This application is co-pending with commonly-assigned U.S. patent application Ser. No. 14/807,491, entitled “Heated Articles of Clothing and Devices Including a Micro-Generator”, filed on the same-day as the present application and including at least one common inventor, and is incorporated herein by reference in its entirety.

This application is co-pending with commonly-assigned U.S. patent application Ser. No. 14/807,630, entitled “Wearable Articles of Clothing including a Micro-Generator and Devices for Producing Heat Therein”, filed on the same-day as the present application and including at least one common inventor, and is incorporated herein by reference in its entirety.

### FIELD OF THE DISCLOSURE

This is generally directed to systems, methods, and devices using a micro-generator that is operable to create substantially immediate heat for gloves and other various articles of clothing. This is also generally directed to systems, methods, and devices for creating a micro-generator operable to create substantially immediate heat with minimal user effort. Furthermore, this is generally directed to systems and methods for using a removable micro-generator to provide energy to various parts of a system for providing warming effects to a user. Still further, this is generally directed to systems, methods, and devices for creating manually heatable articles of clothing.

### BACKGROUND OF THE DISCLOSURE

Heated gloves and other articles of clothing have generally been formed using a heat generation device powered by a battery, capacitor, or exothermic chemical reaction. The heat produced for these devices typically has a finite duration in which the heat that is produced flows through one or more wires or resistive elements while the heat generation device is in an “on” state. For example, heated gloves commonly include a battery having a voltage and one or more resistive wires running through portions of the gloves' liner(s). As electrons move through the wire(s) due to the voltage applied by the battery, inelastic collisions occur between electrons in the wire(s). The energy outputted from the inelastic collisions may take the form of heat in some scenarios, which may be communicated to the gloves' liner(s) in the form of heat.

These types of battery-powered heated gloves, and similarly other battery-powered heated articles of clothing, have a number of drawbacks. For example, batteries inherently have a finite amount of accessible and/or useable energy. The total charge of a battery gradually decreases over time due to he multitude of voltage drops that occur from the various inelastic collisions. This will lead to a user having to replace batteries frequently or, even worse, a user suddenly having a “dead” battery. While it is possible to obtain batteries that are rechargeable, the user still will have to take the battery out of the glove or article of clothing including the battery-powered heating device, and place it in some additional charging device, or some additional circuitry, to recharge the battery or batteries. This can be especially burdensome for a user out in a cold and/or inclement weather environment, who may not have access to a power source to recharge the battery or batteries. If the user cannot recharge the batteries, the user cannot heat their glove or article of clothing, and therefore is unable to enjoy any of the warming benefits that would otherwise have been provided.

In addition to battery-powered heated gloves or articles of clothing, there are also heated gloves or articles of clothing that use exothermic chemical reactions as a mechanism for generating heat to the glove or article of clothing. Typically this type of heat is generated when a user performs some sort of physical action (e.g., compressing a chemical pack), which in turn causes two or more chemicals to interact with one another. The chemicals reacting with one another may generate heat as a byproduct of interacting with one another.

These forms of heated gloves or articles of clothing, however, also have numerous drawbacks for consumers. For example, exothermic chemical reactions are typically singular. In other words, the chemicals cannot be separated after they have been combined, and therefore cannot be reused for another exothermic reaction. Thus, the heat enjoyed by an individual via an exothermic chemical reaction may only be enjoyed once, unless the chemicals can somehow be separated and/or combined again to produce another exothermic reaction. However, even if the chemicals can be reused, such reuse often requires heating the materials to a certain temperature not likely feasible when in an inclement weather environment. Additionally, while a user may be able to replace the chemicals so that additional reactions may occur, that may require the user to have the chemicals, or chemical packs, readily available. Furthermore, the user may find it difficult in certain environmental settings (e.g., extreme cold), to provide the physical action required to cause the chemicals to interact with one another. This may be because the use of these type of heating elements often require the user to remove the article of clothing to install the device after the mixing of the chemicals has taken place, which may result in the user experiencing even more intense effects from the cold. Still further, handling of such chemicals may be hazardous to the consumer as contact with a user's skin, eyes, or mouth may be dangerous or even deadly in certain scenarios.

Thus, it would be beneficial to provide mechanisms and devices that can be incorporated within various products, such as gloves or other articles of clothing, that can produce enough heat to provide a user with the comforts of a battery-powered or chemically-heated glove, but without the many drawbacks previously described.

### SUMMARY OF THE DISCLOSURE

Systems, methods, and devices corresponding to a micro-generator and heated gloves or other articles of clothing including a micro-generator are described herein. In some embodiments, a micro-generator may be provided that is substantially small enough to be incorporated within a glove placed on a user's hand or within another article of clothing. A user may be capable of providing a relatively quick and simple mechanical motion to drive the micro-generator and thereby generate a substantially quick and effective amount of heat within the glove or article of clothing.

In a first exemplary embodiment, an article of clothing including a micro-generator attached to the article of clothing is described. The article of clothing also may include at least one heating element coupled to the micro-generator and integrated within the article of clothing.

In a second exemplary embodiment, a wearable heating device is described. The wearable heating device may include a wearable article including a material, a three-phase micro-generator attached to a first region of the material, and at least one heating element integrated into the wearable article and coupled to the three-phase micro-generator. The micro-generator may include a housing, a set of gears located within the housing, and a micro-alternator coupled to the set of gears. The wearable article may be heated by energy produced by the three-phase micro-generator in response to rotation of the set of gears.

In a third exemplary embodiment, a heated article of clothing is described. The heated article of clothing may include a housing for a micro-generator, a piece of wearable fabric, an arm, and a plurality of heating elements. The housing may be located on a first side of the wearable fabric in a first region of the wearable fabric. The arm may be coupled to the micro-generator and may extend through an opening in the housing. The arm may also be located on a first side of the wearable fabric in the first region. The plurality of heating elements may be integrated into the piece of wearable fabric such that the piece of wearable fabric can be heated by energy generated by the micro-generator.

In a fourth exemplary embodiment, a manually heatable glove is described. The manually heatable glove may include a glove, a housing, a micro-generator, an insert, and at least one conductive element. The housing may include a rotating arm, and may be located along a wrist portion of the glove. The micro-generator may be stored within the housing and may include a set of gears coupled to the rotating arm. The insert may be integrated into the glove and may be located along the wrist portion and at least a portion of the a thumb portion of the glove. The at least one conductive element may also be integrated into the glove, were the at least one conductive element may receive energy from the micro-generator to produce heat in the glove.

In a fifth exemplary embodiment, a wearable article is described. The wearable article may include a glove and a housing for a micro-generator. The housing may include a lower housing portion and an upper housing portion placed on the lower housing portion. The housing may also include a rotating arm coupled to the micro-generator and extending through an opening in the upper housing portion.

In a sixth exemplary embodiment, a device which may include a micro-generator, a housing that houses the micro-generator, and a rotating arm is described. The micro-generator may include a set of gears, a micro-alternator operable to generate an electrical signal in response to rotation of the set of gears, and a connector that may couple the micro-generate to at least one heating element. The rotating arm may be coupled to the set of gears such that rotation of the rotating arm may cause the set of gears to rotate and generate the electrical signal.

In a seventh exemplary embodiment, a wearable article is described. The wearable article may include a micro-generator operable to generate heat in the wearable article, as well as a housing for the micro-generator, which may be integrated into the wearable article. The wearable article may also include a rotating arm coupled to the micro-generator. The rotating arm may extend through an opening in the housing and may include a base member that is substantially disc shaped. The rotating arm may also include a substantially circular portion and a rail portion, where the substantially circular port:on surrounds the disc shaped base member. The rotating arm may further include a first tab member located at a first end of the rail portion, and a second tab member that is attachable to the first tab member.

In an eighth exemplary embodiment, a system for providing heat to an individual is described. The system may include a first wearable article, a second wearable article, and a micro-generator. The first wearable article may include a first heating element integrated into the first wearable article as well as a first connector. The second wearable article may include a second heating element integrated into the second wearable article as well as a second connector. The micro-generator may be removably attachable to at least one of the first connector of the first wearable article and the second connector of the second wearable article.

In a ninth exemplary embodiment, a housing for a micro-generator is described. The housing may include a supporting base plate having a first opening. The housing may also include a lower housing portion located substantially on top of a first side of the supporting base plate. The lower housing portion may include a cavity section that is insertable through the first opening, and a connector port. The housing may also include an upper housing portion that may be engaged with and located on top of the lower housing portion. The upper housing portion may also include a first section including a second opening, and a second section including a first recess and a second recess.

In a tenth exemplary embodiment, a manually heatable blanket is described. The manually heatable blanket may include a blanket made of a material, as well as a plurality of heating elements integrated into the material of the blanket. The manually heatable blanket may also include a micro-generator coupled to a portion of the blanket and operable to heat the blanket using energy produced by the micro-generator.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1A is an illustrative diagram of a glove including a micro-generator in accordance with various embodiments;

FIGS. 1B and 1C are illustrative diagrams of various other articles of clothing including a micro-generator in accordance with various embodiments;

FIG. 1D is an illustrative diagram of a blanket including a micro-generator in accordance with various embodiments;

FIG. 2 is an illustrative diagram of an exemplary micro-generator and micro-generator housing in accordance with various embodiments;

FIG. 3 is an exploded view of the exemplary micro-generator and micro-generator housing of FIG. 2 in accordance with various embodiments;

FIGS. 4 and 5 are illustrative side and front views, respectively, of the exemplary micro-generator housing of FIGS. 2 and 3 in accordance with various embodiments;

FIG. 6 is an illustrative diagram of another exemplary micro-generator housing in accordance with various embodiments;

FIG. 7 is an illustrative diagram of an exemplary micro-generator in accordance with various embodiments;

FIG. 8-11 are illustrative top, rear, bottom, and side views of the exemplary micro-generator of FIG. 7 in accordance with various embodiments;

FIG. 12 is an illustrative cross-sectional view of a micro-alternator for the exemplary micro-generator of FIG. 7 in accordance with various embodiments;

FIG. 13 is an illustrative diagram of yet another exemplary micro-generator housing in accordance with various embodiments;

FIG. 14-16 are various illustrative diagrams view of first and second tab members 330 and 316, respectively, in accordance with various embodiments;

FIGS. 17 and 18 are illustrative perspective and side views, respectively of a rotating arm of a micro-generator housing in accordance with various embodiments;

FIG. 19 is an illustrative diagram of a slide for a rotating arm of a micro-generator housing in accordance with various embodiments;

FIG. 20 is an illustrative diagram of another tab member for rotating arm in accordance with various embodiments;

FIG. 21-25 are illustrative diagrams various exemplary micro-generator housing in accordance with various embodiments;

FIG. 26-30 are illustrative diagrams of another exemplary micro-generator housing and its components in accordance with various embodiments;

FIG. 31 is an illustrative diagram of an exemplary heating element configuration in accordance with various embodiments;

FIG. 32 is an illustrative diagram of another exemplary heating element configuration in accordance with various embodiments;

FIGS. 33A-F are illustrative diagrams of various configurations for a micro-generator incorporated into a glove in accordance with various embodiments;

FIGS. 34A-C are illustrative diagrams of a system for using a micro-generator, such as the micro-generator of FIG. 7, to provide heat to various articles of clothing in accordance with various embodiments;

FIGS. 35A and 35B are illustrative graphs of resistance versus electrical efficiency for various micro-generators in accordance with various embodiments;

FIG. 36 is an illustrative graph of power versus revolutions per minute (“RPM”) for various micro-generators in accordance with various embodiments; and

FIGS. 37A-E are illustrative diagrams of an exemplary insert for use within an article of clothing for a micro-generator housing in accordance with various embodiments.

### DETAILED DESCRIPTION OF THE INVENTION

A manually heatable article of clothing including a micro-generator, as described herein, may allow a user to have a substantially noticeable warming effect created within an article of clothing, such as a glove, shoe, sock, or other article of clothing incorporating a micro-generator. The warming sensation may be felt by the user throughout the particular article of clothing being worn by the user in a substantially small amount of time. The warming sensation may also be strong enough to suitably warm the user (or the particular area of the user's body covered by the article of clothing), without providing adverse effects such as burning or irritation. However, the warming sensation, nonetheless, may still be created with minimal delay.

As used herein, an article of clothing broadly corresponds to any object that may cover or contact a portion of an individual's body. For example, an article of clothing may correspond to a glove, sock, hat, shoe, shirt, jacket, undergarment, scarf, pant, and/or boot. However, an article of clothing may also correspond, in some embodiments, to a blanket, a sheet, a duvet, a throw, a pillow, a mattress, or any other object that may contact an individual. As such, the present disclosure is not limited to the traditional definition of an article of clothing, but is broadly used to encompass any and all objects that may be suitable for providing a warming sensation to an individual.

Micro-generators, as described herein, may be enclosed within a small housing, such as a rectangular or square housing. In some embodiments, the housing of the micro-generator may be affixed to a portion of the article of clothing. The micro-generator may include a set of gears, as well as other various components (e.g., permanent magnets, stators, micro-alternators, etc.), while remaining substantially small enough such that the housing does not hinder movement of the user and/or provide discomfort for the user.

Such micro-generators may also include a mechanical arm, such as a rotating arm, hand crank, spring-loaded arm, pump arm, rotating knob, rack and pinion system, or pulley system, which may be coupled to the micro-generator's set of gears. The mechanical arm may allow a user to provide a mechanical input (e.g., a force) to the mechanical arm, which in turn may cause gears of the micro-generator located within the housing to rotate at a certain rotational velocity. The velocity at which the gears rotate may be fixed or varied, as so desired, and may be related to an amount of power capable of being outputted or needed to generate a suitable heating effect in the article of clothing including the micro-generator.

One or more heating elements, such as conductive wires, filaments, yarns, or threads, may couple to the micro-generator at one location of the micro-generator's housing. The heating elements may extend from the location of the micro-generator's housing, in some embodiments, through a portion of the housing, to various regions of the article of clothing. Gloves, for example, may have one or more conductive threads extending from the housing to various portions the glove (e.g., finger and/or palm portions). In this particular scenario, the conductive threads may extend to the fingertips of the glove(s), enabling a warming sensation to be translated to a user's fingers.

A micro-generator, such as a three-phase micro-generator, may have a variety of functions and uses. In some embodiments, a micro-generator may be integrated into an article of clothing to provide heat to a user wearing the article of clothing. The micro-generator, however, may require certain features, or be subject to certain constraints, to make it useable in such an article of clothing. For example, if the micro-generator is too large, it may become intrusive, cumbersome, and/or uncomfortable for a user, leading the user to not purchase and/or wear the article of clothing, or making it impractical or difficult for the user to utilize the micro-generator feature. As another example, if the micro-generator is too small, it may not be capable of generating enough power to provide a noticeable or a desirable heating effect, or it may require too much mechanical input from the user to be practical. Other factors, such as if the micro-generator is difficult to operate, easily damageable, and/or aesthetically unpleasant, may also contribute to whether or not a user will purchase and/or wear the article of clothing including such a micro-generator.

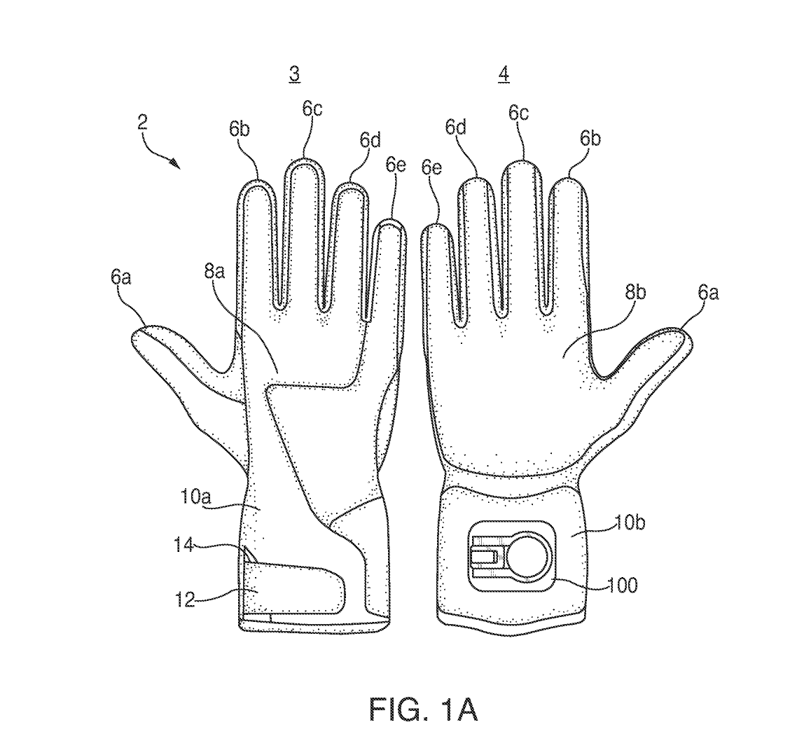

FIG. 1A is an illustrative diagram of a glove including a micro-generator in accordance with various embodiments. Glove 2 is one exemplary embodiment of a manually heatable glove that may be worn by an individual. As shown in FIG. 1A, a “back-of-the-hand” view 3 of glove 2 and a “front-of-the-hand” view 4 of glove 2 are presented side by side. For illustrative purposes, only one glove is shown, however persons of ordinary skill in the art will recognize that another glove 2 for a corresponding hand (e.g., right hand, left hand) may also be represented by the illustrated embodiment.

Glove 2 is substantially glove shaped and may include thumb portion 6a, pointer finger portion 6b, middle finger portion 6c, ring finger portion 6d, and pinky finger portion 6e, each of which may provide cover for a respective finger or digit of an individual's hand when glove 2 is worn by the individual. In some embodiments, however, glove 2 may include a thumb portion 6a and a finger portion where the finger portion may include space for a pointer, middle, ring, and pinky finger, instead of separate portions for each digit. For example, glove 2 may be mitten shaped. However, in other embodiments, glove 2 may include cut-offs at various sections of portions 6a-e such that an individual's finger tips may be exposed.

Glove 2 also may include palm portion 8b and back of the hand portion 8a which are located opposite one another. Palm portion 8b and back of the hand portion 8a may join finger portions 6a-e with wrist portions 10a and 10b. Wrist portion 10a may be an outer wrist portion (e.g., a portion of a glove located proximate to back of the hand portion 8a), while wrist portion 10b may be an inner wrist portion (e.g., located proximate palm portion 8b). Glove 2 may be substantially unitary such that wrist portions 10a and 10b is seamlessly connected to palm portion 8a and back of the wrist portion 8b, which is seamlessly connected to finger portions 6a-e.

In some embodiments, different materials or fabrics may be used to form some or all of portions 6a-e, 8a and 8b, and 10a and 10b. For example, finger portions 6a-e may be formed of a first material or fabric, while portions 8a and 8b may be formed of a second material or fabric, and portions 10a and 10b may be formed of a third material. Various types of material or fabric that may be used to form one or more portions of glove 2 may include, but are not limited to, leather, conductive leather, water resistant leather, water resistant conductive leather, cotton, polyester, denim, flax, silk, and/or fur. In some embodiments, however, each portion of glove 2 may be formed of only one material (e.g., leather) or fabric. In some embodiments, portions of glove 2 may be formed of multiple materials or fabrics. For example, portions of glove 2 may include an outer layer material and an inner layer material with an insulating material located between the outer and inner layer. Furthermore, glove 2 may be any suitable shape, size, and/or color or colors, and may include one or more logos or other insignias adorned to any suitable region or area.

In some embodiments, glove 2 may be formed of one or more layers. For example, glove 2 may include multiple layers including a liner layer, a leather layer, a base layer, a middle layer, and/or a top layer. In some embodiments, one or more of the aforementioned layers may include conductive elements such that glove 2 may be conductive and capable of being used to interact with a touch-screen of a user device (e.g., a smart phone, tablet, laptop computer, and/or desktop computer including a touch-screen). A more detailed description of a systems and methods for forming leather gloves including conductive layers capable of interacting with touch-screens is described in commonly-assigned U.S. Pat. No. 8,507,102, filed on Aug. 7, 2012, and commonly-assigned U.S. patent application Ser. No. 13/958,126, which was filed on Aug. 2, 2013, the disclosures of which are hereby incorporated herein by reference in their entirety. Furthermore, a more detailed descriptions of water-repellant conductive fabrics and methods for making the same is described in commonly-assigned U.S. patent application Ser. No. 13/566,623, filed on Dec. 10, 2014, the disclosure of which is hereby incorporated herein by reference in its entirety.

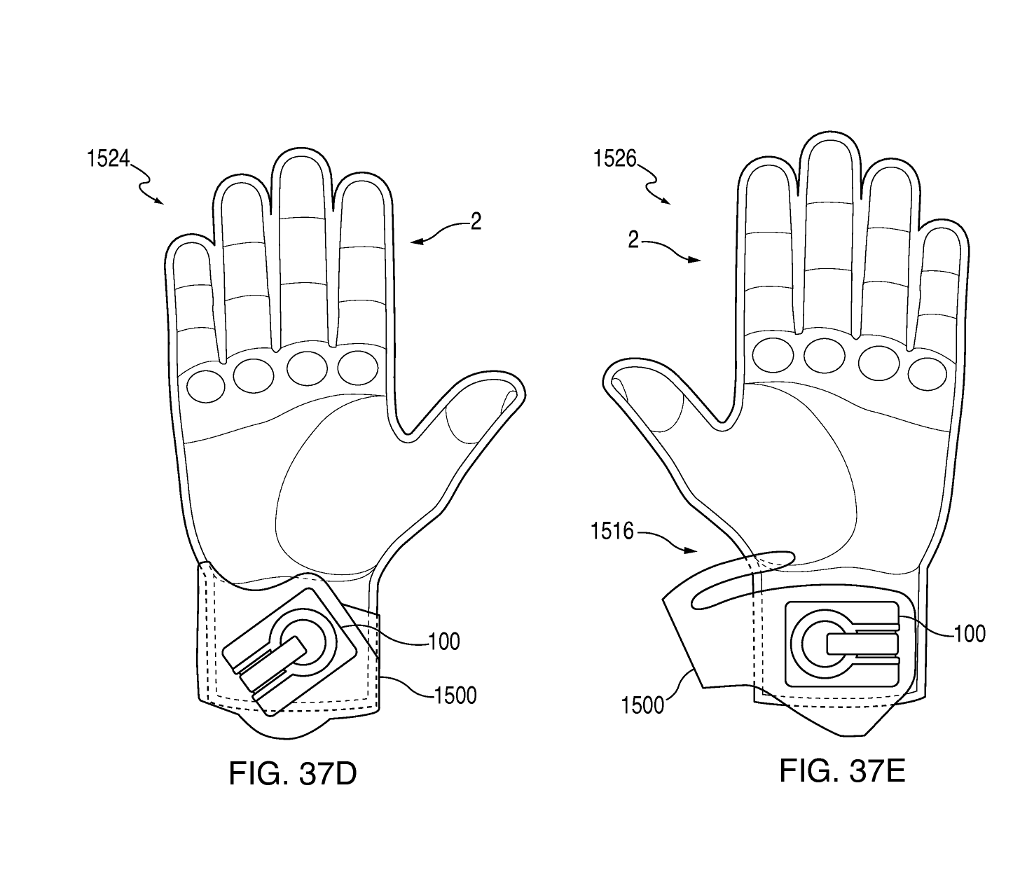

In some embodiments, wrist portions 10a and 10b may be formed of, or may include, a substantially rigid material capable of providing support to a structure located in or on wrist portions 10a and 10b. For example, wrist portions 10a and 10b may include a plastic or foam insert that may wrap around wrist portions 10a and 10b to provide support to wrist portions 10a and 10b. In some embodiments, a portion of the substantially rigid material may extend from wrist portions 10a and 10b to thumb portion 6a (see FIG. 37A-E).

Wrist portion 10a may also, in some embodiments, include strap 12 which may be used to secure glove 2 to an individual's hand. For example, strap 12 may include a mechanical fastening mechanism have a male/female portion located on strap 12, and a counter portion (e.g., female/male) located on wrist portion 10a that allows a user to fasten strap 12 to wrist portion 10a. For example, strap 12 may include a male or female portion of a button, zipper, or fabric hook and loop fastener, and a counter female or male portion may be located on wrist portion 10a. Strap 12 may be located in a recess 14 within wrist portion 10a of glove 2, that enables strap 12 to be extended to any suitable portion about wrist portion 10a. However, in some embodiments, glove 2 may not include strap 12 and/or recess 14, as glove 2 may be sized differently based on an individual's hand size.

In some embodiments, wrist portion 10b may include a micro-generator housing 100, which may also include a micro-generator located therein. Micro-generator housing 100 may be integrally formed with wrist portion 10b of glove 2 such that housing 100 is substantially flush with wrist portion 10b. For example, wrist portion 10b may include a recessed portion (e.g., within a substantially rigid material) that may have housing 100 mounted therein. In some embodiments, the substantially rigid material that may be used to form, at least a part, of wrist portions 10a and 10b may serve to protect housing 100 from damage and/or may serve to protect an individual's wrist (s) from damage due to housing 100.

Housing 100 may be oriented in any suitable manner within, or on, glove 2. For example, housing 100, which may be substantially rectangular in shape having a length shorter than a width, may be oriented such that the shorter side of housing 100 is substantially parallel with a length portion of an individual's arm. However, in other embodiments, housing 100 may be oriented such that the longer side of housing 100 is substantially parallel with the length portion of an individual's arm, or neither the shorter side, or longer side of housing 100 may be parallel with an individual's arm, and housing 100 may be oriented at an angle (e.g., 45-degrees). Persons of ordinary skill in the art will also recognize that housing 100 may have any suitable shape or size, and thus may be configured or oriented in any suitable manner within, or on, glove 2, and the aforementioned is merely one exemplary illustration.

In some embodiments, housing 100 may also be removable from wrist portion 10b. For example, an individual may be able to remove housing 100 from a recess within wrist portion 10b of glove 2 where housing 100, and a micro-generator located therein, may be stored. In this particular scenario, one or more additional straps or covers may also be included on glove 2 that allow the recess that would house housing 100 to be covered. However, persons of ordinary skill in the art will recognize that any orientation of housing 100 about glove 2 is possible including, but not limited to, housing 100 being placed along wrist portion 10a, palm or back of the hand portions 10a and 10b, respectively, on top of wrist portion 10b (e.g., not within a recess), or any other configuration, or any combination thereof. Furthermore, persons of ordinary skill in the art will recognize that although the aforementioned embodiment relates to a glove, any article of clothing may be used instead. For example, housing 100 may also be integrated into a portion of a hat, a shoe, a boot, a sock, a jacket, a shirt, an undergarment, a vest, a scarf, and/or a blanket, or any other article of clothing, or any other wearable article, or any combination thereof.

In some embodiments, housing 100 may be substantially small such that it may be incorporated into an article of clothing including, but not limited to, a glove, shoe, hat, and/or coat, for example. In order for a user to be comfortable wearing such a micro-generator, the micro-generator, and the housing (e.g., housing 100) including the micro-generator, should be of a suitable size such that it does not impede the user's motion or activity, or detract from the aesthetic nature of the article of clothing. However, housing 100 should be substantially large enough to house gears for the micro-generator that are capable of providing a suitable output of power, such as an amount of power required to provide heat, or a heating sensation, to a user wearing the article of clothing. Housing 100 may, for example, be approximately 5.1 cm in length, 5.1 cm in width, and 2.9 cm in height. However this is merely exemplary, and the length may range between 3-6 cm, the width may range between 3-6 cm, and the height may range between 1-3 cm. Furthermore, in other embodiments, the length, width, and/or height may vary from the aforementioned ranges by any suitable amount. For example, the length, width, and height may each range from 1 cm to 10 cm.

FIGS. 1B and 1C are illustrative diagrams of various other articles of clothing including a micro-generator in accordance with various embodiments. In one illustrative embodiment, sock 20 of FIG. 1B may include micro-generator 100. For example, micro-generator 100 may be attached to an upper portion of sock 20 such that a user may access micro-generator 100 without having to remove ones shoe or boot. This may enable a user to provide a heating sensation to various portions of sock 20 by manually inputting energy into micro-generator 100 to generator an electrical signal that is transmitted throughout one or more heating elements integrated into sock 20. In some embodiments, micro-generator 100 of FIG. 1B may be sized differently than if it was used within glove 2 of FIG. 1A. For example, micro-generator 100 of sock 20 may be slightly smaller, thinner, or larger depending on the heat in needs of sock 20.

FIG. 1C includes shirt 40 including micro-generator 100 attached thereto. For example, micro-generator 100 may be located at a lower portion of shirt 40 (e.g., proximate to a user's waist). However, in some embodiments, micro-generator 100 may located at other locations within or on shirt 40. In some embodiments, one or more heating elements may be integrated throughout shirt 40 such that heat may be provided to a user wearing shirt 40 in response to a user manually generating neat using micro-generator 100. In some embodiments, micro-generator 100 of FIG. 1C may be sized differently than micro-generator 100 of FIGS. 1A and 1B. For example, shirt 40 may be substantially larger than glove 2 and/or sock 20 and therefore may require a greater amount of energy to be produced by micro-generator 100 to generate a suitable amount of heat for shirt 40. Thus, in one embodiment, micro-generator 100 of shirt 40 may be slightly larger and operable to output more power than micro-generator 100 of FIGS. 1A and 1B, however persons of ordinary skill in the art will recognize that this is merely exemplary.

FIG. 1D is an illustrative diagram of a blanket including a micro-generator in accordance with various embodiments. Blanket 60 may include material 62, which in the illustrative embodiment may be substantially rectangular. However, any other shape may be used for blanket 62 and the aforementioned is merely exemplary. Furthermore, material 62 of blanket 60 may correspond to any type of material including, but not limited to, silk, cotton, a fur (faux fur or actual animal fur), denim, or any other type of material, or any combination thereof.

In some embodiments, blanket 60 may include micro-generator housing 100 including a micro-generator therein. Housing 100 including the micro-generator may allow an individual to manually generate heat within blanket 60. For example, an individual may manually rotate an arm of housing 100 and the micro-generator, which causes on or more gears of the micro-generator to rotate, and thereby generating an electrical signal within a micro-alternator in the micro-generator. The electrical signal may be communicated to one or more heating elements 64 integrated into material 62 of blanket 60, which thereby produces a warming effect within blanket 60.

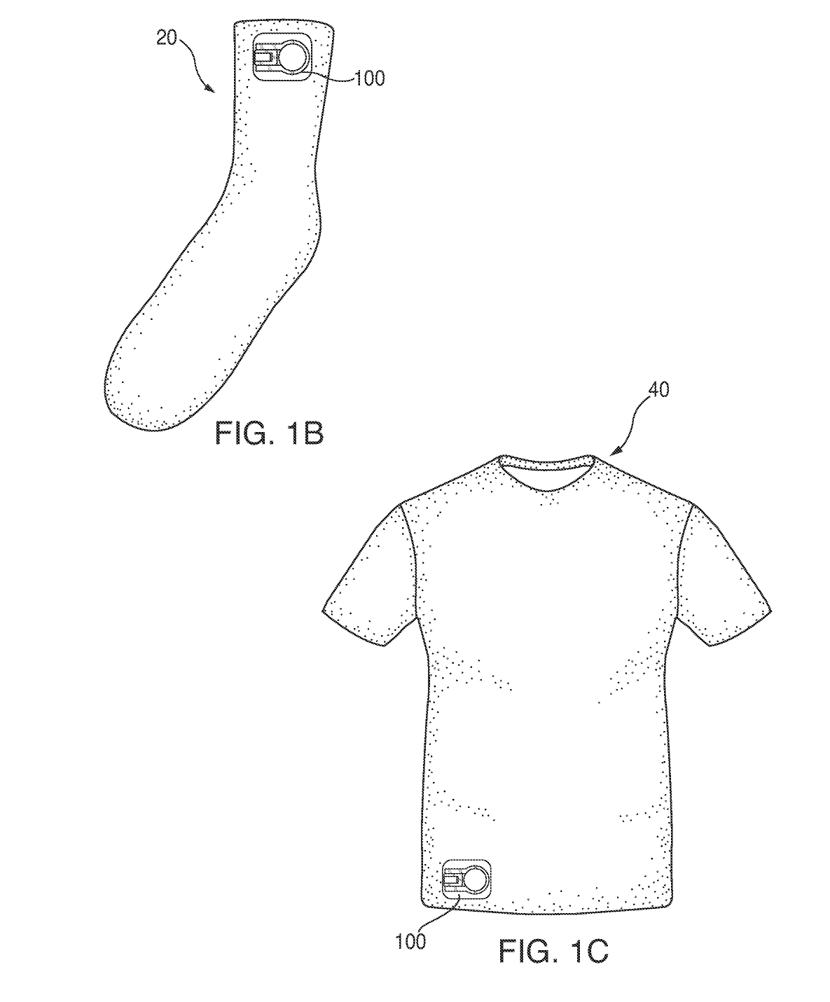

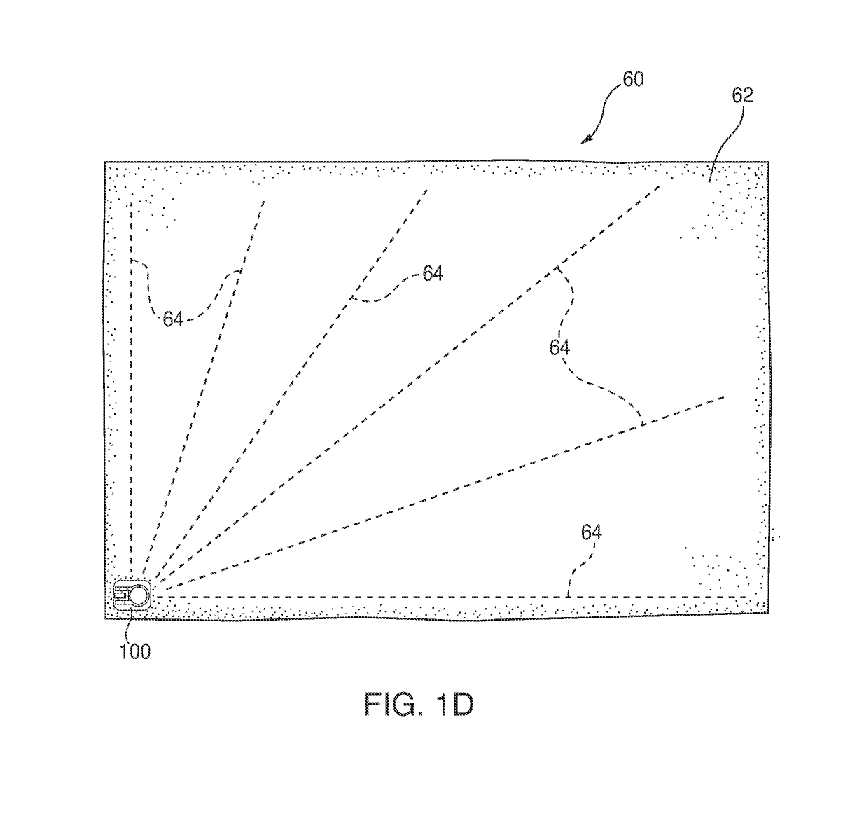

FIG. 2 is an illustrative diagram of an exemplary micro-generator housing 100 in accordance with various embodiments. FIG. 3 is an exploded view of an exemplary micro-generator 200 and micro-generator housing 100 of FIG. 2 in accordance with various embodiments. Micro-generator housing 100 may include an upper housing portion 102 and a lower housing portion 104. Each of upper housing 102 and lower housing 104 may, in some embodiments, be substantially rectangular such that, when upper housing 102 is placed on lower housing portion 104, they engage one another and form a substantially box-shaped structure. However, in some embodiments, upper housing portion 102 and lower housing portion 104 may be substantially square, substantially circular, or any other suitable shape or shapes, and the aforementioned is merely exemplary. In some embodiments, upper housing portion 102 and lower housing portion 104 may be differently shaped or differently sized.

Upper housing portion 102, as described in greater detail below, includes a substantially planar portion segmented into a first section 102a and a second section 102b. First section 102a and second section 102b, in some embodiments, are separated by circular ridge 102c. Circular ridge 102c may reflect a portion of a circumference of rotating arm 108, which may pass over upper housing portion 102. In some embodiments, second section 102b may be set at a different height in relation to first section 102a, and ridge 102c may indicate the separation point along upper housing section 102 of the differently leveled sections.

In some embodiments, an opening 102e may be included within first section 102a of upper housing portion 102. As described in greater detail below, opening 102e may allow a rotating base member 110 and rotating arm 108 to couple to one or more gears of micro-generator 200. Upper housing portion 102 may also include side walls 102d that extend from the substantially planar upper housing portion 102 in a vertical direction towards lower housing portion 104. In some embodiments, side walls 102d may extend along all four sides of the planar upper housing portion 102, and may also be slightly curved. Also extending towards lower housing portion 104 may be support legs 102f which are capable of securing upper housing section 102 to lower housing section 104. For example, support legs 102f may couple upper housing section 102 to lower housing section 104 by one or more screws, fasteners, and/or any other coupling mechanisms attached to, or through, lower housing section 104.

Lower housing portion 104, in some embodiments, may include a substantially planar base portion 104b and four side walls 104a that extend upwards towards upper housing portion 102. For example, two side walls 104a, located on opposite sides of base portion 104b, may extend upwards in a direction perpendicular to base portion 104b and towards upper housing portion 102. Two additional side walls 104a, which may be located on opposite sides of base portion 104b as well as being perpendicular to the previously mentioned side walls 104a, may also extend upwards in the direction perpendicular to base portion 104b and towards upper housing portion 102. This, for example, enables lower housing portion 104 to form a substantially box shaped structure with upper housing portion 102 serving as a “top”.

In some embodiments, a cavity section 120 may extend outward from the substantially planar portion of lower housing portion 120 in a direction opposite that of upper housing portion 102. Cavity section 120 may be capable of housing a micro-alternator for micro-generator 200 that may be placed within housing 100. In some embodiments, cavity section 120 may be substantially circular in shape, however persons of ordinary skill in the art will recognize that cavity section 120 may be any suitable shape and size. Cavity section 120 of lower housing portion 104 may include a side wall or walls 104c. For example, in the exemplary illustrative embodiment, cavity section 120 is substantially circular in shape, and therefore cavity section 120 may include only a single side wall 104c. However, if cavity section 120 were rectangular, four (4) side walls 104c may be included instead. Cavity base 104d may correspond to an interior base section of cavity section 120, which may be substantially parallel to planar base portion 104b in some embodiments.

Housing 100 may also include rotating arm 108 which is capable of being rotated about a rotating base member 110. Rotating base member 110, in some embodiments, is located on first section 102a of upper housing portion 102, and may be substantially disc shaped. By being substantially disc shaped, rotating base member 110 is capable of having a substantially low profile such that it does not protrude extensively above upper housing section 102. In some embodiments, rotating base member 110 may be coupled to one or more gears of micro-generator 200. When base member 110 is rotated, the rotational motion is translated to the gear it is coupled to, causing that gear, and any subsequent gears coupled thereto, to rotate as well. Rotating base member 110 may include coupling bar(s) 110a, which may extend through opening 102e of upper housing section 102, and couple to one or more gears of micro-generator 200.

Rotating arm 108 may be coupled to rotating base member 110 in some embodiments. For example, a portion of rotating base member 110 may extend outwards and form a portion of rotating arm 108 such that rotating arm 108 and base member 110 are substantially unitary. In some embodiments, rotating arm 108 and base member 110 be formed together and act as a single component. When rotating arm 108 rotates, the rotational motion of rotating arm 108 may be communicated to rotating base member 110, which in turn may cause one or more gears of micro-generator 200 that are coupled to rotating base member 110 to rotate. Rotating arm 108 may include a curved section 108a that extends around a circumference of rotating base member 110. In some embodiments, curved section 108a of rotating arm 108 may fully surround the perimeter of rotating base member 110. However, in some embodiments, curved section 108a may only surround a portion (e.g., half, three-fourths, etc.) of the circumference of rotating base member 110. In some embodiments, a gap 108a-1 may be formed between rotating base member 110 and curved section 108a of rotating arm 108. For example, gap 108a-1 may allow rotating arm 108 to rotate freely about rotating base member 110 while minimizing frictional forces between rotating arm 108 and base member 110. However, persons of ordinary skill in the art will recognize that gap 108a-1 may be any suitable size, and in some embodiments, may not be included.

Extending away from curved section 108a, in some embodiments, may be rails 108b of rotating arm 108. Rails 108b may extend away from curved section 108a along a planar surface of upper housing section 102. For example, rails 108b may extend from section 102a to section 102b. In some embodiments, rails 108b may extend to an edge of section 102b of upper housing section 102. While two (2) rails 108b are shown within FIGS. 2 and 3, persons of ordinary skill in the art will recognize that this is merely exemplary, and any number of rails may be used.

Rails 108b, in one embodiment, may include rail channels 108b-1, which may extend along a length of an inner side of rails 108b. Rail channels 108b-1 enable an object, such as a slide 112, described in greater detail below, to be moved along the length of rails 108b. Rail channels 108b-1 may be flanked on an upper and lower side of rail section 108b by sections 108b-4 and 108b-3, respectively, which may be protrusions that extend inwards (e.g., towards an opposing rail section 108b) to form channel 108b-1. An outer section 108b-2 of rails 108b may be coupled to outer surface 108a-2 of curved section 108a such that a substantially continuous outer section is formed between curved section 108a and rails 108b. End portions 108d may be substantially parallel to a side wail 102d of a front side of upper housing portion 102 such that rails 108b extend to an edge of upper housing section 102. In some embodiments, rails 108b may also include stoppers 108c located proximate end portions 108d within rail channels 108b-1. Stoppers 108c may be any suitable structure capable of preventing an object, such as slide 112, from over extending past rails 108b and becoming decoupled from rotating arm 108.

Slide 112 may, in some embodiments, include a first part 112a that may be substantially equal in length to a distance between rails 108b such that slide 112 may integrally fit between rails 108b. In some embodiments, first part 112a may be curved or rounded to integrally fit with, or abut, rotating base member 110 when slide 112 is not extended. For example, when in a “storing configuration”, first part 112a of slide 112 may be substantially contacting a portion of base member 110 such that slide 112 is not extended along rails 108b. In a “use configuration”, for example, slide 112 may be extended along rails 108b such that first part 112a is located substantially proximate to the end of rails 108b (e.g., proximate to stoppers 108c).

Extending away from first part 112a are second parts 112b, which may be substantially parallel to rails 108b such that when slide 112 is inserted between rails 108b, second parts 112b of slide 112 engage channels 108b-1 of rails 108b. In some embodiments, second parts 112b may include channel portion 112b-1 flanked by protrusions such that channel portion 112b-1 may engage with protrusions 108b-3 and/or 108b-4 to allow slide 112 to slide along a length of rails 108b.

Located at an end 112b-3 of second parts 112b of slide 112 may be opening 112c. In some embodiments, a pin or rod may be placed through opening 112c to extend through an opening 114a of a foldable member 114, such that foldable member 114 couples to slide 112. Foldable member 114 is capable of rotating along a longitudinal axis of the pin or rod inserted through openings 112c and 114a, to allow a tab member 116 to move from a folded position to an upright position. When in a folded position, tab meaner 116 is lowered into an area formed between second parts 112b such that an outer surface 116b of tab member 116 is substantially flush with second sections 112b. In an upright position, tab member 116 may extend away from the planar surface of upper housing section 102 such that it is substantially perpendicular to second sections 112b. However, persons of ordinary skill in the art will recognize that, in some embodiments, foldable member 114 may include protrusions extending into opening 112c such that no pin may be needed.

Extending outwards from foldable arm 114 is a connector pin 118 that extends through tab member 116 to couple foldable arm 114 to tab member 116. In some embodiments, connector pin 118 may snap-fit into tab member 116, however persons of ordinary skill in the art will recognize that any coupling mechanism may be used to couple the two components together including, but not limited to, an adhesive, a pressure fit, a screw, or any other coupling mechanism, or any combination thereof.

In some embodiments, tab member 116 may include an opening 116e located on outer surface 116b, such that connector pin 118 may be viewable when inserted into tab member 116. Outer surface 116d may be located on an opposite side of tab member 116 from inner surface 116a. Tab member 116 may also include top side 116d and a side 116c. Tab member 116, in one embodiment, is capable of rotating along a longitudinal axis 118A of connector pin 118. For example, tab member 116 may be capable of being rotated clockwise and/or counter-clockwise along a longitudinal axis of connector pin 118 such that inner surface 116a and/or outer surface 116b are oriented for an individual to grip tab member 116. In some embodiments, an individual may apply a force to tab member 116 in a direction substantially parallel to opening 114a (e.g., perpendicular to a length of rails 108b), which in turn may cause rotating arm 108 to rotate about base member 110. In some embodiments, tab member 116 may be placed in a “lock” position when tab member 116 is rotated such that inner surface 116a and outer surface 116b are substantially perpendicular to a longitudinal axis of foldable arm 114. Thus, in the lock position, an individual may apply a force to tab member 116 and tab member 116 will remain in its lock position.

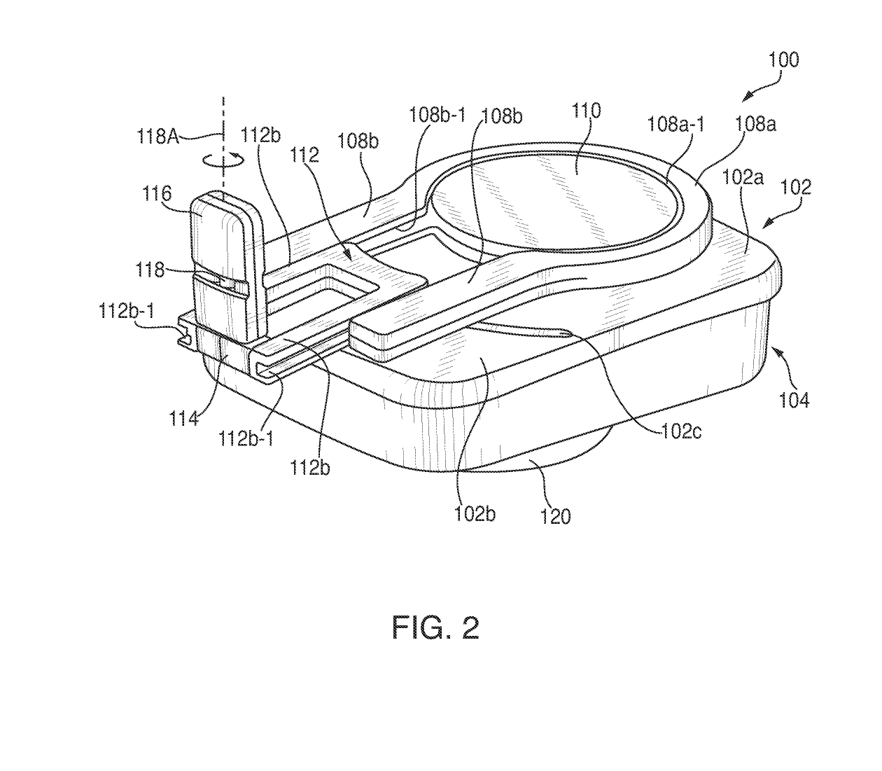

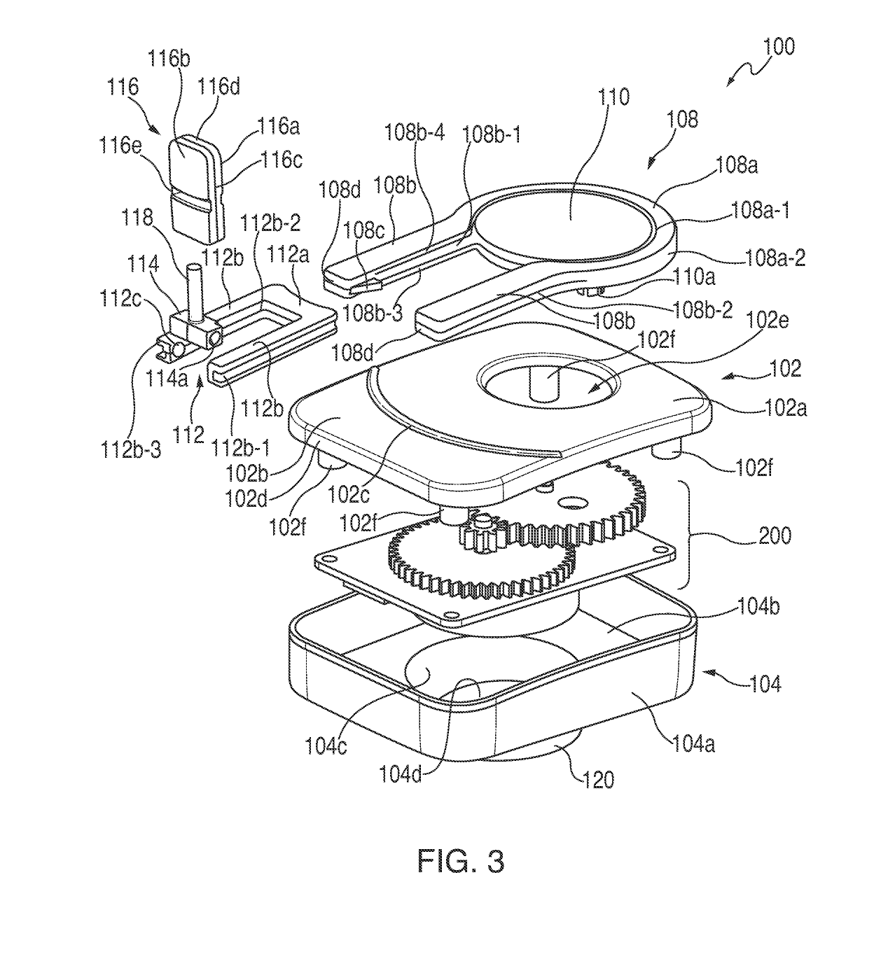

FIGS. 4 and 5 are illustrative side and front views, respectively, of micro-generator housing 100 of FIGS. 2 and 3 in accordance with various embodiments. In one exemplary embodiment, micro-generator housing 100 may include cavity section 120, which may extend outward from lower housing portion 104. For example, cavity section 120 may extend section downward, away from upper housing portion 102. In some embodiments, cavity section 120 may be slightly offset from a center of lower housing portion 104. For example, as seen in FIG. 4, housing cavity section 120 may be located a distance t1 from a back end of lower housing section 104, and a distance t2 from a front end of lower housing section 104. In one illustrative example, distances t1 and t2 are different. For example, distance t2 may be greater than distance t1. However this is merely exemplary and cavity section 120 may be located at any distance with respect to the front or back end of lower housing portion 104. Furthermore, persons of ordinary skill in the art will recognize that the front or back end may correspond to any side of housing portions 102 and 104.

In some embodiments, slide 112 may extend outwards from rotating arm 208 by a distance t3 when in the use configuration. As mentioned above, slide 112 may slide along rails 108b of rotating arm 108. For example, slide 112 may be retracted into rotating arm 108 such that distance t3 is approximately zero when in the scoring configuration. In this particular scenario, slide 112 is not extended and may be in a storing mode where no rotation of rotating arm 108 may occur. As another example, when a user intends to rotate rotating arm 108 to generate heat for their article of clothing (e.g., a glove) using micro-generator 200, slide 112 may be extended outwards along rails 108b of rotating arm 108 to an extended position (e.g., the use configuration). In this particular scenario, side 112 may extend outwards away from end 108d of rotating arm 108 by a distance t3, such that a user may freely rotate rotating arm 108 about base member 110. Slide 112 may also be able to be placed in an intermediate position, in some embodiments, such that its distance extended away from end 108d is less than distance t3, but greater than zero.

In some embodiments, lower housing 104 may have a length t4. Length t4 may, for example, range between 25.4-50.8 mm, however in one exemplary embodiment, length t4 may be approximately 55.5 mm. In some embodiments, upper housing 202 may also have a length t4, however in other embodiments, upper housing may have a slightly greater length. For example, upper housing 102 may have a length ranging between 20-55 mm.

Upper housing 102 may have a width w1. For example, width w1 may range between 25.4-38.1 mm. Lower housing 104 may, in some embodiments, have a width w2, which may be slightly less than width w1. In one exemplary embodiment, width w1 may be approximately 44.38 mm. However, width w1 and w2 may vary from the aforementioned values such that widths w1 and w2 may range between 20-45 mm.

Lower housing 104 may have a height h1, whereas upper housing 102 may have a height h2. Heights h1 and h2 may be any suitable height such that gears for the micro-generator may be capable of fitting inside an inner cavity formed when lower and upper housings 102 and 104 are placed together. For example, heights h1 and h2 may have a total height ranging between 5 and 30 mm. In one particular embodiments, height h1 may be slightly larger than height h2. For example, height h1 may be 8.0 mm whereas height h2 may equal 3 mm. Cavity section 102 may extend outwards away from lower housing section 104 by a distance h3. Distance h3 may be any suitable distance such that one or more components of a micro-generator, such as a micro-alternator and/or magnets, may be placed therein. For example, distance h3 may be approximately 11 mm, or may range between 5.0 and 30 mm. In one particular embodiment, the total height of heights h1-h3 may equal approximately 28.58 mm. Persons of ordinary skill in the art will recognize that any value may be used for t1-4, w1 and w2, and h1-3, and the aforementioned are merely exemplary. Furthermore, in some embodiments, housing 100 may be differently shaped (e.g., square, circular, oval, etc.), and thus the aforementioned values are not to be construed as limiting the present invention to only being rectangular.

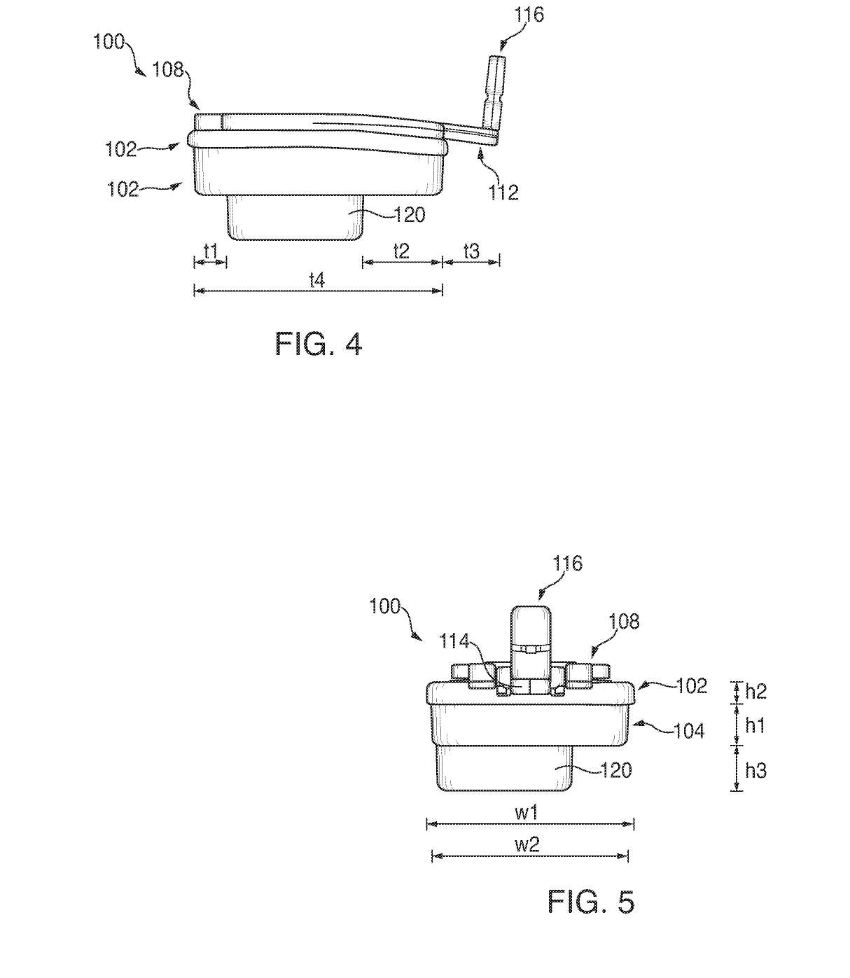

FIG. 6 is an illustrative diagram of another exemplary micro-generator housing in accordance with various embodiments. Micro-generator housing 150 may, in some embodiments, be substantially similar to housing 100, with the exception that rotating arm 158 may differ from rotating arm 108. In some embodiments, curved section 158a of rotating arm 158 may be slightly thinner than curved section 108a of housing 108. Furthermore, rails 158b of rotating arm 158 may be spaced further apart from one another, in one embodiment, as compared to rails 108b of rotating arm 108.

The configuration of housing 150 may enable, in some embodiments, tab member 156 to be slightly larger than tab member 116 of housing 100. Tab member 156 may be coupled to foldable arm 164 by connector pin 158. Connector pin 168 may extend through tab member 156, and may enable tab member 156 to rotate about axis 168A. In some embodiments, foldable arm 164 may enable tab member 156 to be placed within an opening defined by slide 162. For example, slide 162 may include first part 162a and second parts 162b, which may be spaced apart from one another. First part 162a and second parts 162b of slide 162 may, in some embodiments, be substantially similar to first part 112a and second parts 112b of slide 112, with the exception that the former may be slightly larger in size. When foldable arm 164 is rotated about a longitudinal axis, tab member 156 folds into the opening between second parts 162b of sliding arm 162. This allows tab member 156 and slide 162 to fit within an opening defined by the separation between rails 158b of rotating arm 158.

As seen in FIG. 6, first part 162a of slide 162 may be slightly wider and thinner than first section 112a of slide 112. This may widen the spacing between second parts 162b of slide 162, enabling tab member 156 to be slightly wider and longer than tab member 116 of housing 100. However, persons of ordinary skill in the art will recognize that tab member 116 may also be used within housing 150, and the use of a wider and/or longer tab member 156 is merely exemplary.

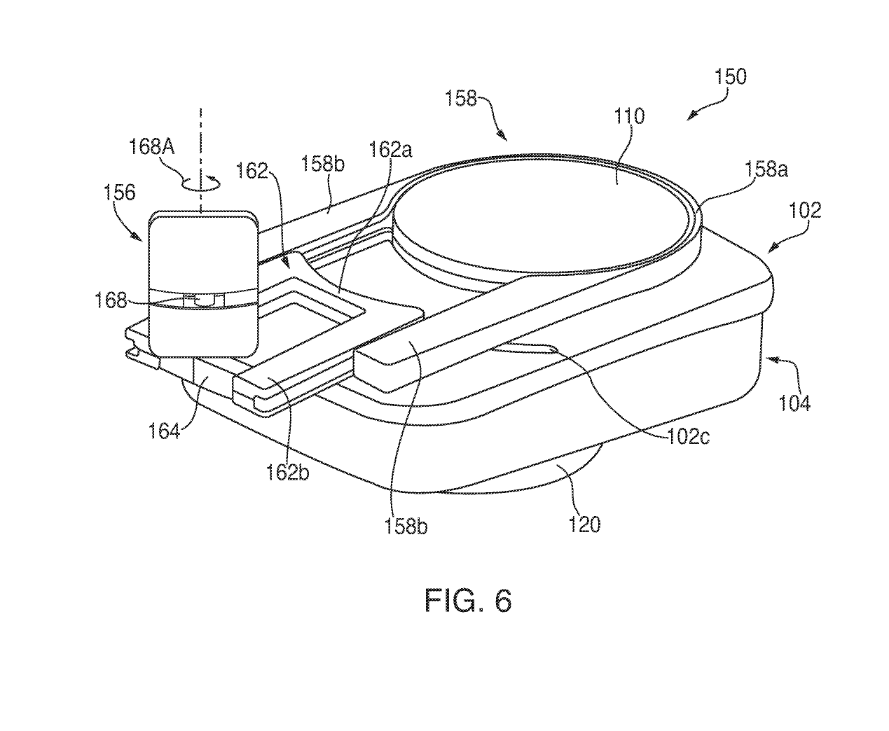

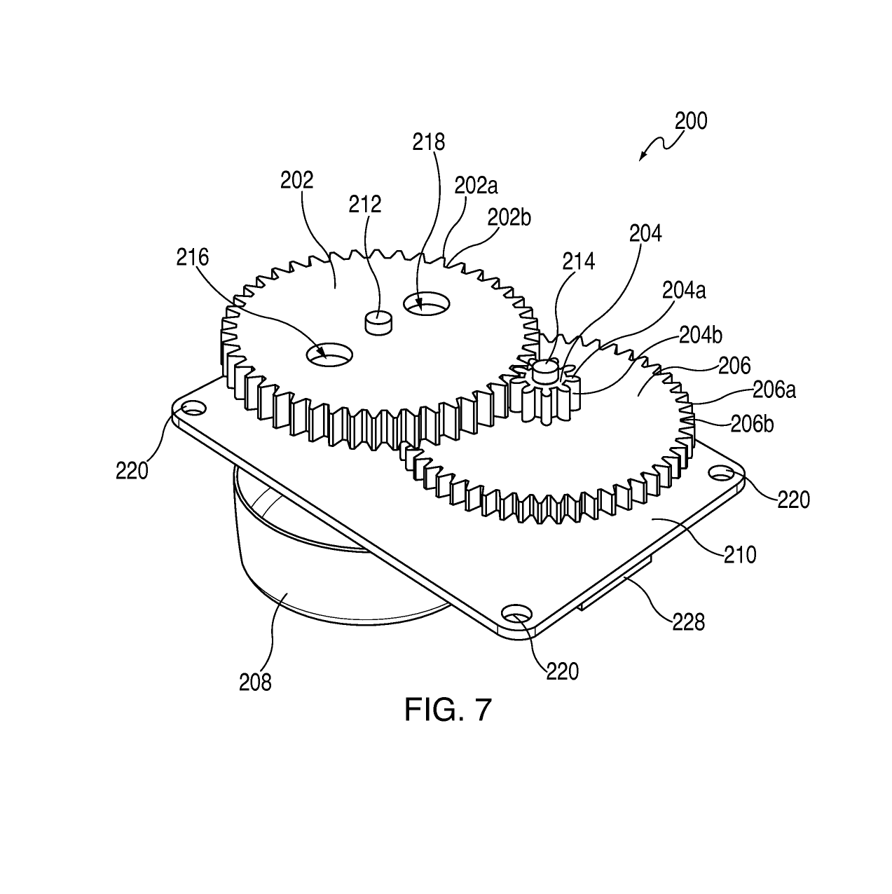

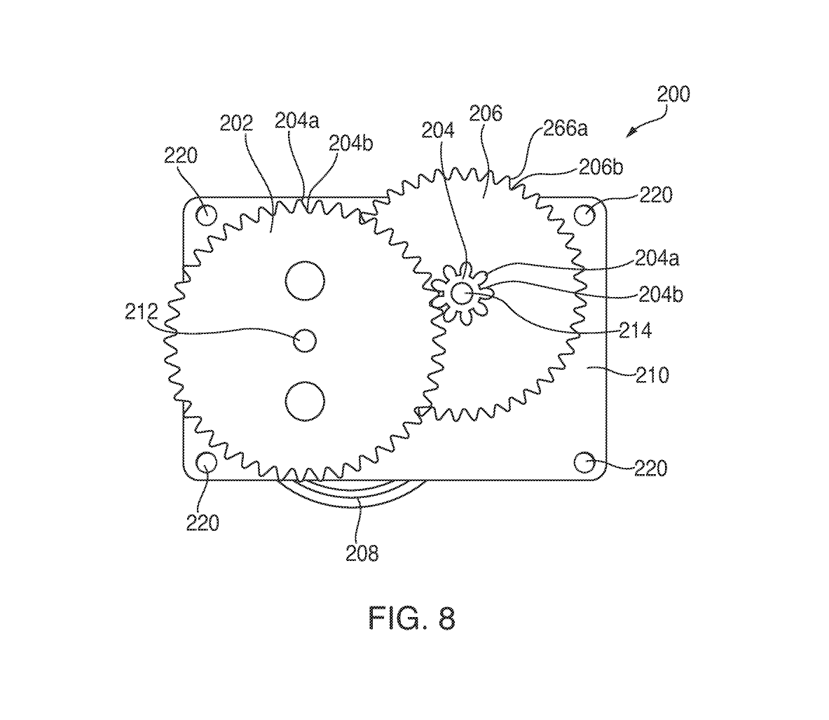

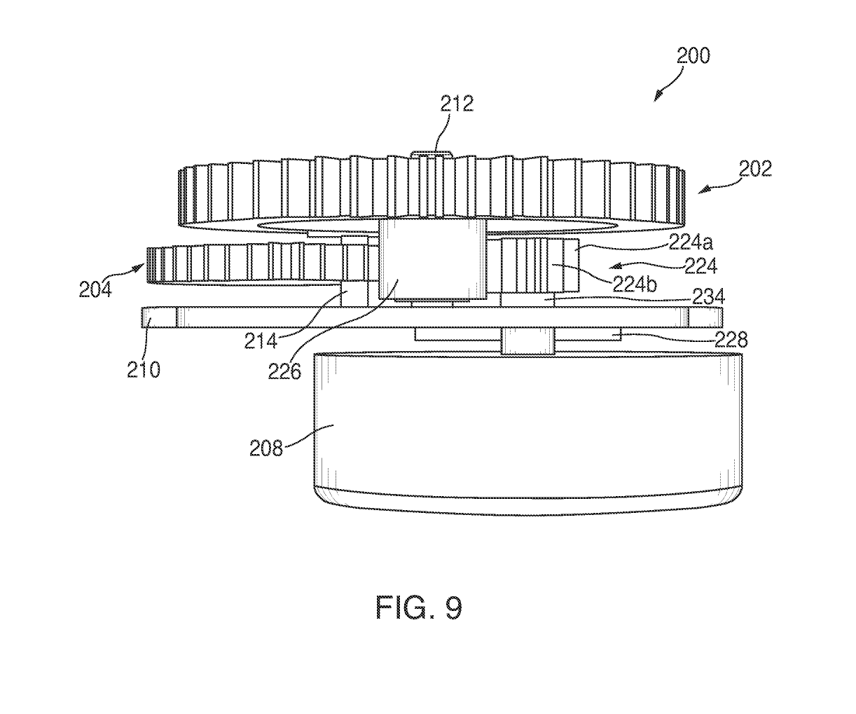

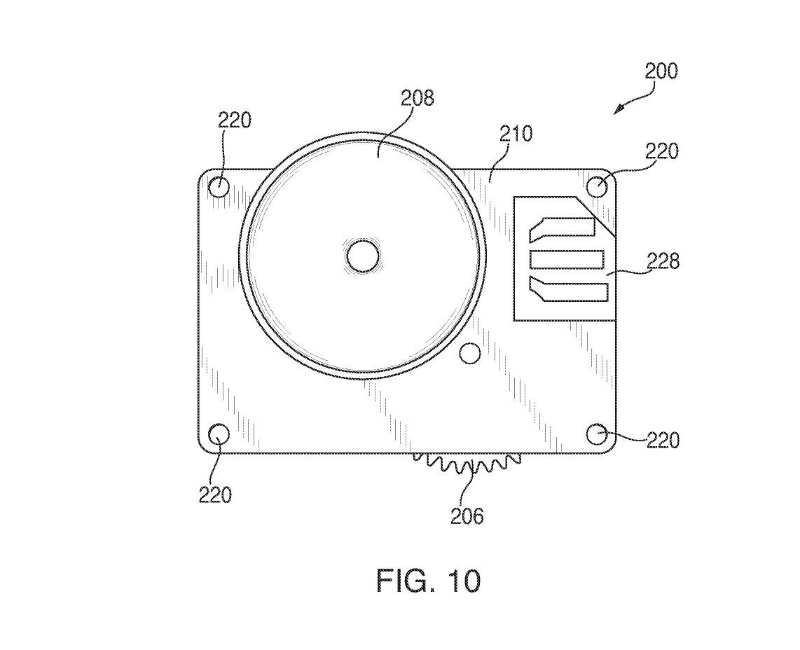

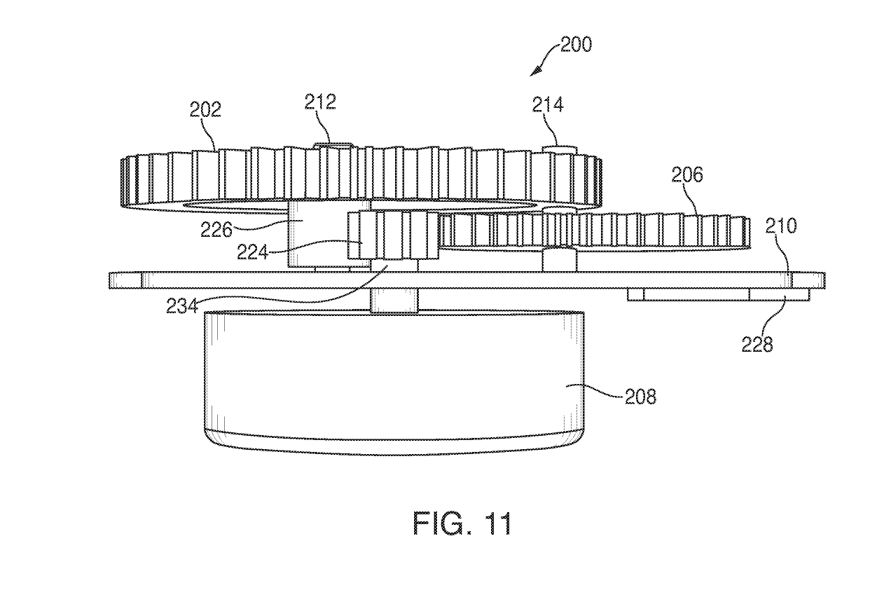

FIG. 7 is an illustrative diagram of exemplary micro-generator 200 in accordance with various embodiments. FIG. 8-11 are illustrative top, rear, bottom, and side views of exemplary micro-generator 200 of FIG. 7 in accordance with various embodiments. FIG. 12 is an illustrative cross-sectional view of a micro-alternator for the exemplary micro-generator of FIG. 7 in accordance with various embodiments. Micro-generator 200 may include supporting base plate 210. Supporting base plate 210, in one embodiment, may be substantially rectangular in shape such that it may fit within housing 100, 150. Supporting base plate 210 may be made of any substantially rigid material including, but not limited to, steel, plastic, copper, or any other type of material, or any combination thereof. Supporting base plate 210 may also include one or more openings 220, which in one embodiment, may be placed along each corner of substantially rectangular shaped supporting base plate 210. For example, supporting base plate 210 may include four (4) openings 220 located proximate to each of the four corners of supporting base plate 210. In some embodiments, openings 220 may be used to couple upper housing 102, supporting base plate 210, and lower housing 104 together. For example, one or more coupling members (e.g., screws) may connect support leg 102f of upper housing portion 102 to lower housing portion 104 through openings 220.

Located on a first side of supporting base plate 210 may be a set of gears. For example, the set of gears may include gears 202, 204, 206, and 224. Extending from the first side of supporting base plate 210 through a center of gear 202 is support bar 212. Gear 202, in some embodiments, is capable of rotating about an axis defined by support bar 212. Gear 202 may also include openings 216 and 218. Openings 216 and 218 may couple to couple bars 110a of base member 110. When rotating arm 108 is rotated, the rotational motion is translated to rotating base member 110, which in turn is translated to gear 202.

Gear 202 may also include a plurality of teeth 202a, which may run along an exterior perimeter of gear 202, and may extend outwards from the exterior perimeter of gear 202. Between each tooth 202a is a recess 202b. In some embodiments, teeth 202a and recesses 202b of gear 202 may engage teeth 204a and recesses 204b of gear 204. When gear 202 is rotated, teeth 202a of gear 202 may engage with a recess 204b of gear 204, and teeth 204a of gear 204 may engage with a recess 202b of gear 202. This enables the rotational motion of gear 202 to be translated to gear 204. Gear 204, in some embodiments, may be smaller in size than gear 202. This may enable gear 204 to rotate faster than gear 202. For example, if gear 202 includes twenty (20) evenly spaced teeth 202a and gear 204 includes ten (10) evenly spaced teeth, when gear 202 completes one rotation, gear 204 will have completed two rotations.

Extending from the first side of supporting base plate 210 through a center of gear 204, in one embodiment, may be supporting bar 214. Supporting bar 214 may secure gear 204 at a first height above supporting base plate 210 such that gear 206 may reside between gear 204 and supporting base plate 210. For example, an outer surface of gear 204 may be located at a distance of approximately 8.0 mm from a first side of supporting base plate 210. In some embodiment, support member 226 may be included on support bar 212. Support member 226 may be placed over support bar 212 such that gear 202 may rest thereon so that gear 202 is located at a desired height above supporting base plate 210. In some embodiments, support member 226 may be capable of allowing gear 202 to rotate freely, however in other embodiments, supporting member 226 may provide an appropriate amount of resistance to the rotational motion of gear 202.

Gear 206 may be integrally coupled to supporting bar 214 such that, when gear 204 rotates, the rotational motion is translated from gear 204 to support bar 214, and thus to gear 206. Gear 206 may include a plurality of teeth 206a and recesses 206b, which may be substantially similar to teeth 202a and recesses 202b of gear 202, however the former may engage with recesses 224b and teeth 224a, respectively, of gear 224. In some embodiments, gear 206 may be larger than gears 202 and/or 204, however gear 206 may be any suitable size.

In some embodiments, gear 224 may be located between gear 202 and support plate 210. For example, a lower surface of gear 202 may be located at a height of approximately 5.0 mm above the first side of supporting base plate 210. Gear 224 may, therefore, be located at a height lower than 5.0 mm from the first side of supporting base plate 210. Support bar 234 may extend from supporting base plate 210 through a center of gear 224 such that gear 224 is capable of rotating about an axis of support bar 234. In some embodiments, gear 224 may be located at a first end of support bar 234, while rotating alternator housing 208 may be located at a second end.

In some embodiments, micro-generator 100 may include an alternating current (“AC”) permanent magnet wound stator alternator, such as alternator 250 of FIG. 12 which may be stored or located within rotating alternator housing 208. Such an alternator may use a rotating magnet 258 with a stationary set of conductors wound in coils 254 around a stator 256, or core. By rotating the magnet 258, an induced electromotive force (“EMF”) may be generated, which in turn induces an AC voltage in coils 254 and/or the stator 256. Persons of ordinary skill in the art will recognize that although rotating magnet 258 is described herein, micro-alternator 250 may not be circular such that rotation of magnet 258 about coils 254 and stators 256 occurs. For example, a magnet passing along a conductor in a linear manner may also induce an EMF which induces an AC voltage in coils 254 and stators 256.

In some embodiments, one or more wires 252 may be coupled to coils 254 and/or stators 256. Wires 252 may enable the induced voltage within coils 254 and/or stators 256 to be communicated to PCB 228 located on supporting base plate 210. In this way, PCB 228 may communicate the induced voltage to one or more heating elements integrated into an article of clothing, such as glove 2, to produce heat therein. In some embodiments, PCB 228 may be coupled to a male or female end of a connector, which in turn may couple to a respective female or male end of another connector coupled to the one or more heating elements in the article of clothing. In this way, micro-generator 200 may be coupled to the article of clothing via the connectors. For example, this may enable micro-generator 200 stored within housing 100 to be removable from the article of clothing and coupled to another article of clothing via that other article of clothing's connector.

A three-phase micro-generator, such as, for example, micro-generator 200, may include three sets of stators 256, each being offset from one another such that the rotating magnetic field would produce a three-phase current. Each phase of the current may be displaced by a third of a period of oscillation from one another. A single AC cycle may be produced each time a pair of field poles pass over a point on the stator such that the outputted frequency relates to the number of poles and the rotational speed of the magnet.

In some embodiments, micro-generator 200 may include a twelve (12) pole cylindrical permanent magnet 258 that rotates about a nine (9) pole stator, such as stator 256. For such a configuration, a rotational velocity of 3000 revolutions per minute (“RPM”) with a 28:1 gear ratio may allow a user to provide an angular velocity to rotating arm 108, 158 of approximately two (2) revolutions per second. These parameters may allow micro-generator 200 to produce a voltage between 3-7 Volts with a 0.5 Ampere current, with an AC frequency of approximately 600 Hz. However, the frequency, voltage, and current may all be varied depending on the rotational velocity provided. In some embodiments, generator 200 may be capable of producing approximately 3 Watts of power based on the aforementioned settings, however this value may vary depending on the applied load to the generator (e.g., resistance of heating elements coupled to micro-generator 200). Persons of ordinary skill in the art will recognize that other power outputs may be possible for other micro-generators, and the aforementioned is merely exemplary. For example, micro-generators 100 may correspond to a 6 Watt AC micro-generator that may be operable to produce a voltage of approximately 4 Volts with approximately 0.9 Amperes at 3000 RPM. As another example, micro-generator 200 may correspond to a 10 Watt AC micro-generator that may be operable to produce a voltage between 6-12 Volts at approximately 1.0 Amperes at 3000 RPM. In yet another example, micro-generator 200 may have a 20:1 gear ratio that may be operable to output 8.5 Volts at 3000 RPM in an unloaded state, and 4.2 Volts at 3000 RPM in an approximately 230 milliamperes (“mA”) loading state. Persons of ordinary skill in the art will recognize that the number of permanent magnets and stators, and the output voltages, currents, and RPM may vary depending on micro-generator 200 specific configuration, and the aforementioned are merely exemplary. Furthermore, as used herein, a gear ratio, as signified by a first number and a second number separated by a semi-colon, corresponds to an amount of rotations that the permanent magnets perform in response to a single rotation of rotating arm 108. For example, for a 20:1 gear ratio, rotating arm 108 completing one revolution (e.g., 360 degrees), gear 224, which is directly coupled to the permanent magnets that rotate about the stators, will rotate twenty (20) times.

Gears 202, 204, 206, and 224 may, in some embodiments, each be a different size and/or shape. For example, each of gears 202, 204, 206, and 224 may be substantially circular, with gear 202 being larger than gear 204, 206, and 224, while gear 206 may be larger than gears 204 and 224. Each gear may range in size so that micro-generator 200 may have a three gear step function. For example, gears 202, 204, 206, and 224 may each have a diameter between 5.0-10 mm, 1.0-6.0 mm, 3.0-8.0 mm, and 1.0-6.0 mm, respectively. Persons of ordinary skill in the art, however, will recognize that each of gears 202, 204, 206, and 224 may have a diameter of any suitable size, and in any suitable unit (e.g., SI units), and the aforementioned values are merely exemplary. For example, in some embodiments gear 206 may be larger than gears 202, 204, and 224, or gear 204 may be larger than gears 202, 206, and 224.

In one exemplary embodiment, a size of gears 202, 204, 206, and 224 may be defined by each gear's modules. A gear's modules, for example, is one technique of providing a size of that gear with respect to a number of teeth the gear includes and the gear's diameter (see Equation 1).

modules=diameter/number of teeth Equation 1

Gear 202, in one embodiment, may have a metric modules of 0.6 M, with 45 teeth, or 45 T. Thus, gear 202 may have a diameter of approximately 27 mm. Gear 204, in one embodiment, may have a metric modules of 0.6 M, with 9 teeth, or 9 T, and thus a diameter of approximately 5.4 mm. Gear 206, in one embodiment, may have a metric modules of 0.5 N with 50 teeth (50 T), having a diameter of approximately 25 mm. Gear 224, in one embodiment, may have a metric modules of 0.5 M with 10 teeth (10 T), having a diameter of approximately 5.0 mm.

In one exemplary embodiment, one or more of gears 202, 204, 206, and 224 may be overlaid on top of one another. For example, gear 202 may be placed substantially on top of gear 224 and a portion of gear 206. As another example, gear 204 may reside above gear 206. Overlaying of various gears may enable micro-generator 200 to retain a substantially compact size while including the appropriate number of gears required for a particular output voltage and/or power. Furthermore, persons of ordinary skill in the art will recognize that any number of gears may be included within micro-generator 200, and the various gears may take on any suitable configuration, and the aforementioned is merely exemplary.

In one embodiment, supporting base plate 210 may also include a printed circuit board 228 (“PCB”) located on the second side at a front end of supporting base plate 210. PCB 228 may, in some embodiments, be capable of communicating the energy produced by micro-generator 200 to one or more heating elements within an article of clothing, such as glove 2 of FIG. 1A. In some embodiments, PCB 228 may couple to a connector located on, or connected to, the article of clothing, such that micro-generator 200 may easily connect to the article of clothing. For example, PCB 228 may connect to a connector located on glove 2 through an opening within micro-generator housing 100, 150.

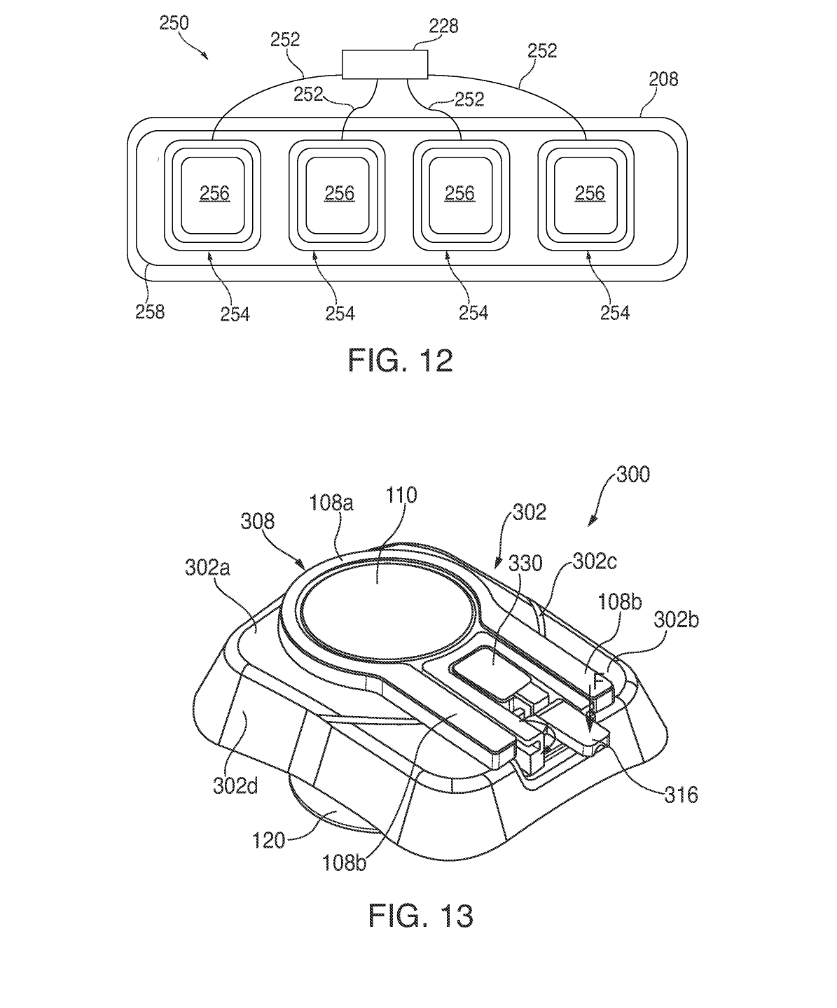

FIG. 13 is an illustrative diagram of yet another exemplary micro-generator housing 300 in accordance with various embodiments. Housing 300 may include upper housing portion 302 which may reside on top of a lower housing section. In some embodiments, housing 300 may be substantially similar to housing 100, with the exception that the former may have an upper housing portion 302 that may be configured differently than upper housing portion 102 of the latter.

Upper housing portion 302 may include a substantially rectangular planar portion segmented into a first section 302a and a second section 302b. First and second sections 302a and 302b may be separated by circular ridge 302c. In some embodiments, first and section sections 302a and 302b and circular ridge 302c may be substantially similar to first and second sections 102a and 102b and circular ridge 102c of upper housing portion 102, and the previous description may apply. Upper housing portion 302 may also include side walls 302d, which may extend downwards away from first and second sections 302a and 302b. Side walls 302d may be substantially similar to side walls 102d, with the exception that the former may be angled and/or beveled, whereas the latter may be substantially straight. For example, side walls 302d may extend away from first and second sections 302a and 302b downward and outward. Side walls 302d may be beveled such that upper housing portion 302, when viewed from above, may be slightly wider at an end of section 302a and an end of section 302b than at a mid-point where sections 302a and 302b meet with circular ridge 302c. However, persons of ordinary skill in the art will recognize that any suitable configuration of side walls 302d may be used, and the aforementioned is merely exemplary.

In some embodiments, micro-generator housing 300 may also include slide 312 located between rails 108b of rotating arm 308. Slide 312, which may be substantially similar to slide 112, is slideable along a length of rails 108b. For example, in a storing configuration, as shown in FIG. 7, slide 312 may be in retracted such that first part 312a of slide 312 substantially abuts rotating base member 110. Slide 312 may also be capable of being placed in a use configuration, as detailed previously in FIG. 2, where slide 312 may be slide along rails 108b such that first section 312a is substantially proximate to ends 108b-3 of rails 108b.

Housing 300 may also include first tab member 330 and second tab member 316. First and second tab members 330 and 316 may be integrally connected such that when a user applies a force F to second tab member 316 in a downward direction (e.g., towards lower housing section 104 or cavity section 120), tab members 330 and 316 rotate such that first tab member 330 flips upwards. When first tab member 330 is in an upward position, a user may be capable of applying another force to tab member 330 in a direction perpendicular to force F that may cause rotating arm 308 to rotate about base member 110. If a user no longer wants to rotate rotating arm 308, then the user may apply a force to tab member 330 to cause tab member 330 to return to a storage position between second parts 312b of slide 312, which in turn causes tab member 316 to return to its original position (e.g., storing configuration) as shown in FIG. 13. In some embodiments, tab member 330 may rotate about an axis aligned with force F when in an upward position such that tab member 330 may spin. This particular example may be substantially similar to tab member 156 of housing 150, in that tab member 156 may rotate about axis 158A.

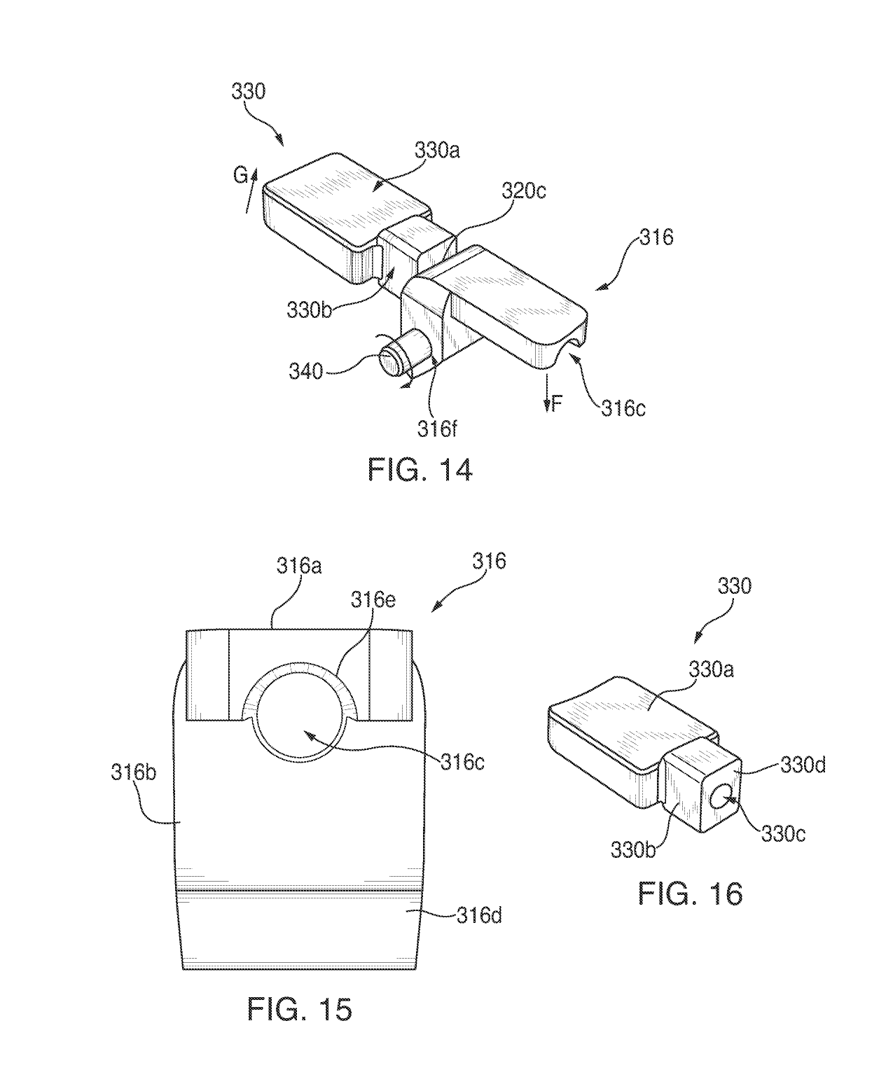

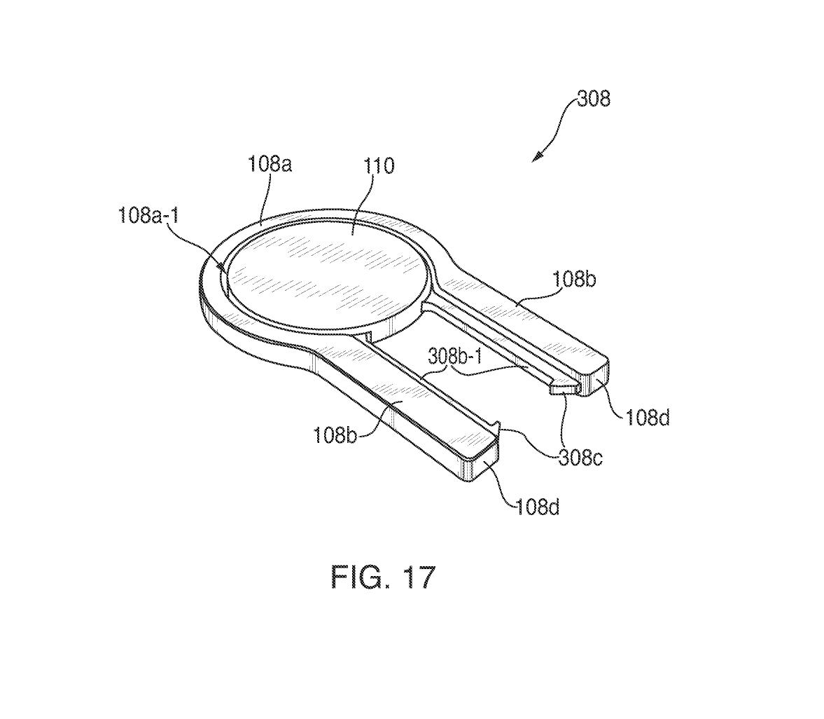

FIG. 14-16 are various illustrative diagrams of first and second tab members 330 and 316, respectively, in accordance with various embodiments. In some embodiments, tab members 330 and 316 may be coupled to one another through openings 330c and 316c of tab members 330 and 316, respectively. For example, a pin, rod, or other coupling mechanism may be inserted through openings 316c and 330c to couple first and second tab members 330 and 316, together. In some embodiments, an adhesive or bonding agent may be used in conjunction with, or instead of, a pin or rod to couple first and second tab members 330 and 316 together.

First and second tab members 330 and 316 may, when coupled together, form a substantially unitary tab member for rotating arm 308 of housing 300. For example, when a user presses tab 316 in a downward direction as indicated by force F, tab member 330 will in turn rotate upwards in a direction opposite that of force F, such as direction G. In some embodiments, first and second tab members 330 and 316 may be formed together, such that a unitary structure is created. However, in other embodiments, first tab member 330 and second tab member 316 may be formed separately and joined together.

First and second tab members 330 and 316 are operable to rotate, when joined together, about a longitudinal axis of a pin 340. Pin 340, as mentioned previously, may be connected to rails 108b of rotating arm 308. This enables tab members 330 and 316 to rotate about the longitudinal axis of pin 340 along rotating arm 308. Furthermore, pin 340, by coupling to rotating arm 308, secures tab members 330 and 316 with rotating arm 308 of housing 300.

First tab member 330 includes, in some embodiments, first section 330a and second section 330b. First section 330a and second section 330b are integrally formed together. For example, first and second sections 330a, 330b may be formed out of a single mold or structure, or may be coupled together to form one piece. First section 330a is, in some embodiments, the portion of tab member 330 that a user will interact with to cause rotating arm 308 to rotate about base member 110. For example, when a user apples force F to second tab member 316, second to member 316 may rotate about the longitudinal axis of pin 340 in a downward direction (e.g., the direction of force F), and in turn, first tab member 330 will rotate upward in direction G. In a final position, tab member 330 may be oriented substantially upright and similar to tab member 116 of housing 100 as shown in FIG. 2. Thus, a user may apply a second force to first section 330a of tab member 330, which in turn may cause rotating arm 308 to rotate.

First section 330a of tab member 330 may be a main or primary portion that a user may interact with when applying a force thereto causing rotating arm 308 to rotate. First section 330a may be substantially rectangular in shape in some embodiments, however other configurations are also possible including, but not limited to, square, circular, disc, or any other shape, or any combination thereof. In some embodiments, one or more ends of first section 330, such as a top end, may be slightly curved. Second section 330b of tab member 330 may be coupled to a lower end of first section 330a. In some embodiments, second section 330b may be thicker in certain portions than first section 330a. This may provide additional support for second section 330b, as second section 330b also may include opening 330c, which may have a pin inserted therein. Side 330d may, in some embodiments, abut or be substantially proximate to second tab member 316. For example, when a pin is used to join tab members 330 and 316, side 330d may substantially abut a section of can member 316 (e.g., second section 316b).

Tab member 316 may, in some embodiments, include first section 316a and second section 316b. First and second sections 316a and 316b may be substantially perpendicular to one another and coupled to one another at an end of both. For example, sections 316a and 316b may approximately form a right angle when joined together. First section 316a may, in some embodiments, be substantially rectangular, however any other configuration may be used. A beveled section 316e may also be included in first section 316a. Beveled section 316e may run along a length of first section 316a to opening 316c in second section 316b. In some embodiments, beveled section 316e may be aligned with opening 316c such that a pin may be inserted along beveled section 316e, through opening 316c, into opening 330c of first tab member 330. In some embodiments, second tab member 316 may also include angled portion 316d, which may be located at a base of second section 316b, which may enable second tab 316 to be folded into one or more recesses within upper housing portion 302 of housing 300. However, persons of ordinary skill in the art will recognize that angled portion 316d may not be included in some embodiments, or may be configured in any suitable manner such that second tab member 316 may fold into a portion of housing 300. In some embodiments, angled portion 316d may include an opening 316f, which pin 340 may extend through when being used to secure tab member 316 to side 312. Thus, opening 316f may be substantially similar in size to pin 340 such that pin 340 may extend through angled portion 316d of tab member 316. In some embodiments, tab member 316 may not include an opening 316f, and tab member 316 may instead include portions of pin 340 located on either side of angled portion 316. This may allow can member 316 to be “snapped” into slide 312 by placing pin 340 of tab member 316 into openings 312e of side 312, as described in greater detail below.

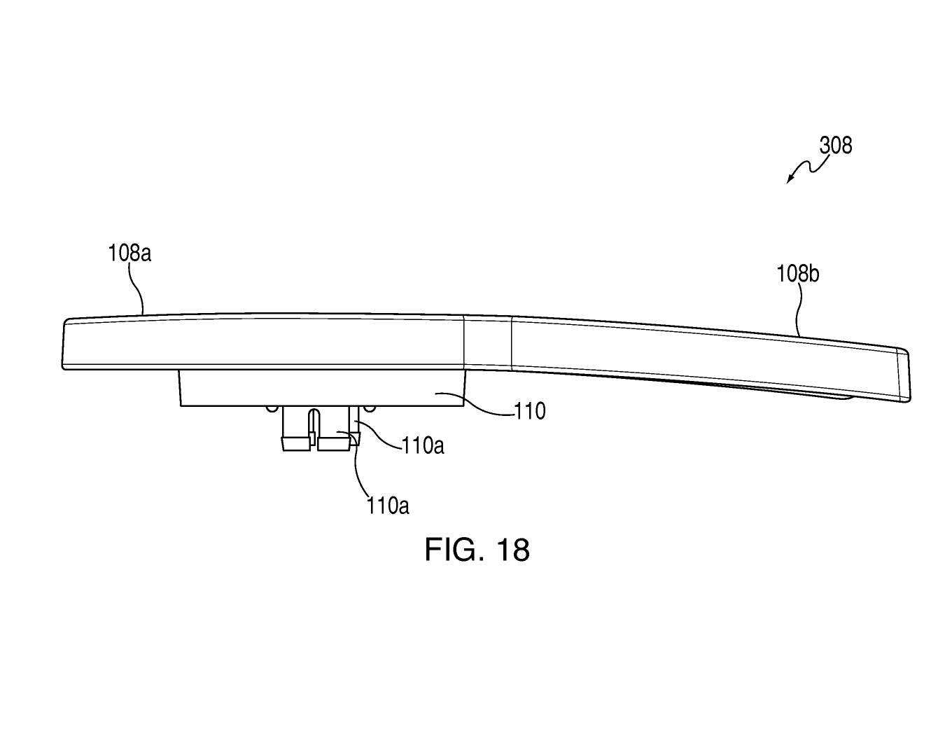

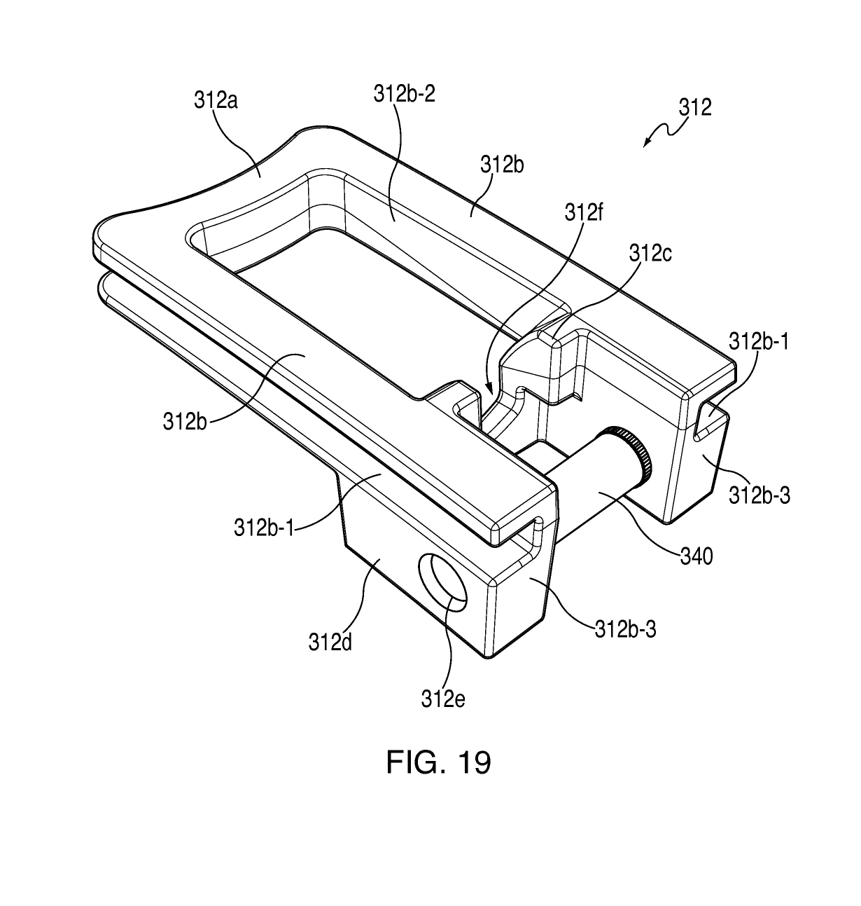

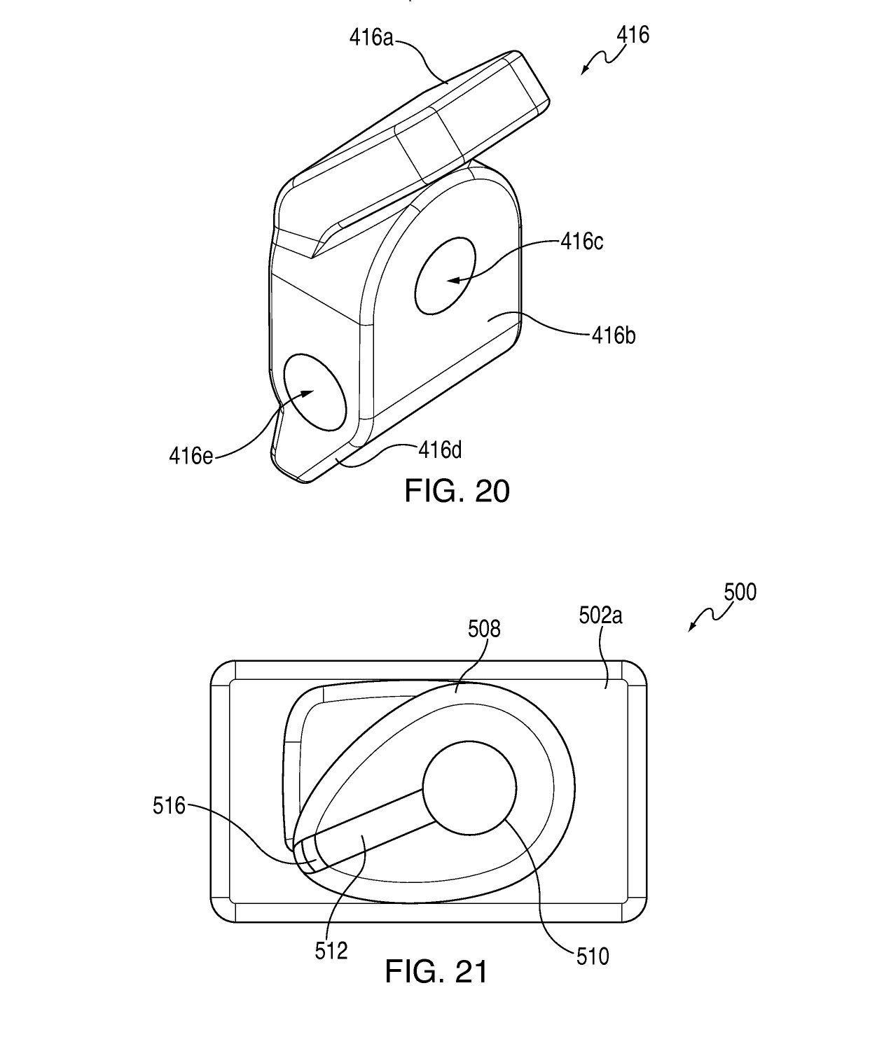

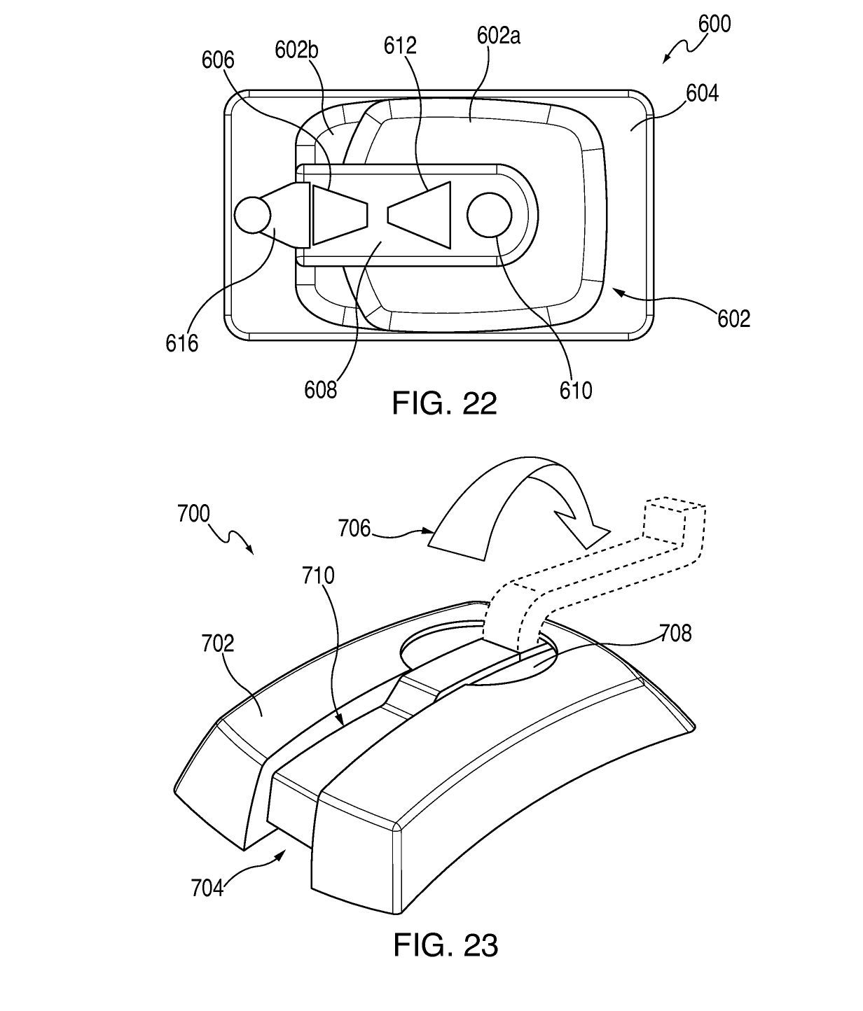

FIGS. 17 and 18 are illustrative perspective and side views, respectively, of rotating arm 308 in accordance with various embodiments. Rotating arm 308, in some embodiments, may be substantially similar to rotating arm 108 of housing 100 with the exception that the former may include inner rail protrusion 308b-1. However, rotating arm 308 of FIGS. 16 and 17 may be used in conjunction with one or more of housings 100 and/or 150, or any other housing. For example, rotating arm 308 may be used with housing 100 or housing 300.

Rotating arm 308, in some embodiments, may include a sight curvature along its length. For example, as seen in FIG. 18, rail 108b may be slightly curved. The amount of curvature of rails 108b and/or curved section 108a may depend on the configuration of upper housing section 102 and/or 302. This may allow a slide, such as slide 312, to slide along the curvature of rails 108b following the configuration of housing section 102 and/or 302.

Running along an inner portion or rails 108b of rotating arm 308 may be inner rail protrusion 308b-1. Inner rail protrusion 308b-1 may be substantially rectangular and may extend along a length of rails 108b from base member 110 to end 108d of rails 108b. At end 108d of rails 108b, in some embodiments, may be stoppers 308c. Stoppers 308c may prevent slide 312 from sliding past end 308d of rails 108b, and therefore no longer being coupled to rotating arm 308. In some embodiments, stoppers 308c may be substantially triangular in shape, and may protrude an additional distance inward towards an opposing inner rail protrusion 308b-1, therefore prevent slide 312 from being removed from rotating arm 308.

FIG. 18 is an illustrative diagram of slide 312 for rotating arm 308 of micro-generator housing 300 in accordance with various embodiments. Slide 312, in some embodiments, includes curved bar 312a, which may be curved such that it aligns with the curvature of base member 110. Extending away from both ends curved bar 312a may be rails 312b. Rails 312b extend in a direction that is perpendicular to and away from curved bar 312a. In some embodiments, rails 312b may have a substantially similar curvature as that of rails 108b of rotating arm 308. This may enable slide 312 to be moved along a length of rails 108b, following the curved path of rails 108b.

Rails 312b, in some embodiments, include an inner side 312b-2 that may be proximate to first tab member 330 when first tab member 330 is in the storing configuration (e.g., as seen in FIG. 13). An outer side 312b-1 of rails 312b may be substantially “U”-shaped, such that inner rail protrusions 308b-1 may fit into the cavity of “U”-shaped outer side 312b-1. End 312b-3 may be located at an opposite end of rails 312b from curved bar 312a. Extending in a first direction (e.g., downward), from rails 312b at end 312b-3 may be rail base 312d, which may be located on either side of rails 312b. Rail base 312d may, in some embodiments, include opening 312e. Pin 340, as previously described, may be inserted through opening 312e on either side of rail base 312d. In some embodiments, second tab member 316 (and first tab member 330) may be placed within slide 312 such that openings 312e are substantially aligned with openings 316f of tab member 316. Pin 340 may then be placed through openings 316f and 312e to secure tab member 316 to slide 312.

Slide 312 may also include cross bar 312c, in some embodiments, which may also include recess 312f. Cross bar 312c may prevent tab member 330 from being pushed into upper housing portion 302. For example, when tab member 330 (and tab member 316) are in the storage configuration, tab member 330 may reside in a space formed between curved bar 312a and rails 312b. In particular, first section 330a, may be located in the space formed between rails 312a proximate to inner side 312b-2. Second section 330b may be located, in the storage position, within recess 312f.

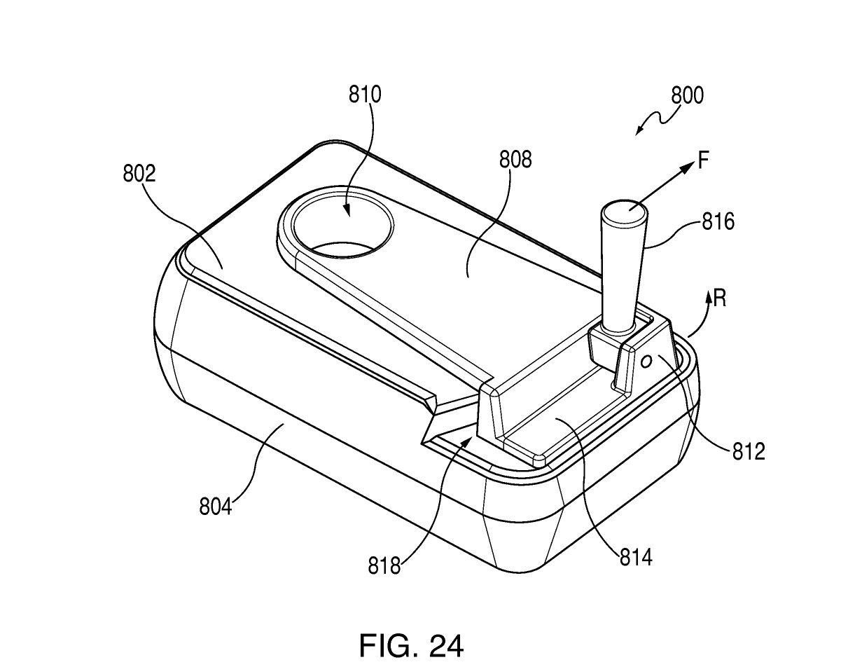

FIG. 20 is an illustrative diagram of another tab member 416 for rotating arm 308 in accordance with various embodiments. Tab member 416, in some embodiments, may include an upper portion 416a and a lower portion 416b. A user may provide a force on upper portion 416a which may cause tab member 416 to rotate about a longitudinal axis of pin 340, which may be inserted through opening 416e. When tab member 416a rotates about the longitudinal axis of pin 340, another tab member, such as tab member 330, may rotate upwards, enabling a user to operate rotating arm 308 coupled thereto.

In some embodiments, tab member 416 may be coupled to tab member 330 via a pin extending through opening 416c into opening 330c of tab member 330. By extending through openings 416c and 330c, a pin or rod may be used to connect tab members 330 and 416 such that they form a substantially unitary object. However, persons of ordinary skill in the art will recognize that any coupling mechanism may be used to couple tab members 416 and 330, and in some embodiments, tab members 416 and 330 may be formed together.

In some embodiments, tab member 416 may include angled portion 416d, which may be angled to facilitate storage of tab member 416 when rotated. Thus, when a user intends to rotate rotating arm 308, tab member 416 may be rotated clockwise along a longitudinal axis of opening 416e (and/or pin 340) to cause tab member 416 to rotate into a recessed portion of upper housing portion 302 of housing 300. In some embodiments, upper portion 416a of tab member 416 may also be angled. Angling upper portion 416a, may allow a user to provide a force to tab member 416 causing it to rotate about the longitudinal axis of opening 416e. However, persons of ordinary skill in the art will recognize that upper portion 416a may be angled in any suitable way, and the aforementioned example is merely illustrative. Furthermore, as shown in conjunction with tab member 316, upper portion 416 may be perpendicular to lower portion 416b, in some embodiments.

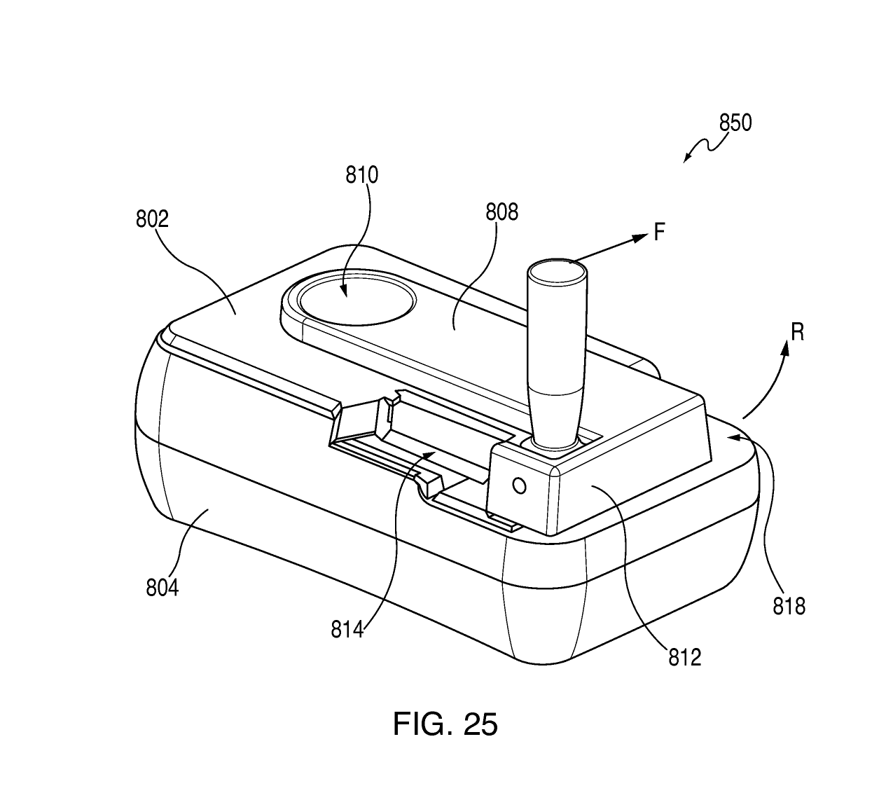

FIG. 21-25 are illustrative diagrams of various exemplary micro-generator housing in accordance with various embodiments. Micro-generator housing 500, in some embodiments, may include rotating arm 508 that rotates about rotating base member 510. Both rotating arm 508 and rotating base member 510 may be located on upper housing portion 502 of micro-generator housing 500. In some embodiments, rotating arm 508, rotating base member 510, and upper housing portion 502 may be substantially similar to rotating arm 108, 110, and 102 of housing 100, with the exception that rotating arm 508 may not include rails (e.g., rails 108b).

In some embodiments, rotating arm 508 may be substantially oval or egg-shaped. Rotating base member 510 may, for example, be located at one end of egg-shaped rotating arm 508, while tab member 516 may be located at another end. Tab member 516, in some embodiments, is substantially similar to tab member 116 of housing 100, and the previous description may apply. For example, tab member 516 may rotate about a pin that couples tab member 516 to rotating arm 508. When a user intends to rotate rotating arm 508 about base member 510, tab member 516 may be oriented in an upright position such that a user may apply a tangential force to tab member 516 that causes rotating arm 508 to rotate.

In some embodiments, a user may fold tab member 516 into a groove 512 within rotating arm 508 when tab member 516 is not being used to facilitate rotation of rotating arm 508. For example, if a user does not intended to apply heat to an article of clothing coupled to micro-generator 200 stored within housing 500, tab member 516 may be folded into groove 512. This may enable tab member 516 to be substantially flush with rotating arm 508 such that tab member 516 does not protrude, or has a minimal amount of protrusion, away from a surface of egg-shaped rotating arm 508. Thus, housing 500 may have a substantially planar profile, which may be functionally and aesthetically beneficial.

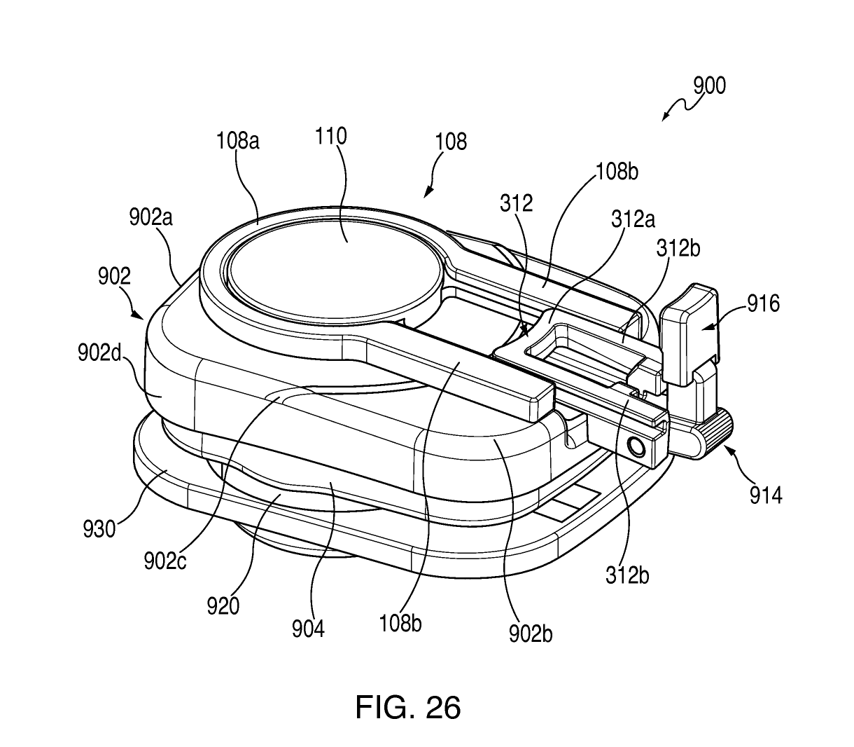

Housing 600 of FIG. 22, in some embodiments, may include lower housing portion 604 and upper housing portion 602, which in some embodiments, may be substantially similar to upper and lower housing portions 102 and 104 of housing 100, and the previous description may apply. In some embodiments, lower housing portion 604 may be substantially rectangular in shape. Upper housing portion 602, in some embodiments, may also be substantially rectangular in shape, however upper housing portion 602 may be smaller than lower housing portion 604. For example, when viewed from above, upper housing portion 602 and lower housing portion 604 may be visible. In this particular example, upper housing portion 602 may reside on lower housing portion 604.

In some embodiments, upper housing portion 602 may include first section 602a and second section 602b. Rotating arm 608 rotates about rotating base member 610 such that tab member 616 rotates along a groove formed within second section 602b of upper house portion 602. Tab member 616 is capable of being folded when not in use into first opening 606 and/or second opening 612. In some embodiments, one portion of tab member 616 may be stored in first opening 606 and a second portion of tab member 616 may be stored in opening 612.

When a user applies a force to tab member 616 to rotate rotating arm 608, gears (e.g., gears 202, 204, 206, and 224) within housing 600 may rotate, which in turn may generate heat within one or more heating elements coupled to the gears. In some embodiments, lower housing portion 604 may be coupled to a portion of an article of clothing, such as a glove. The various heating elements may be integrated or connected to the article of clothing, such that rotation of rotating arm 608 causes gears within housing 600 to rotate, thus generated heat in the heating elements that may be felt in the article of clothing.

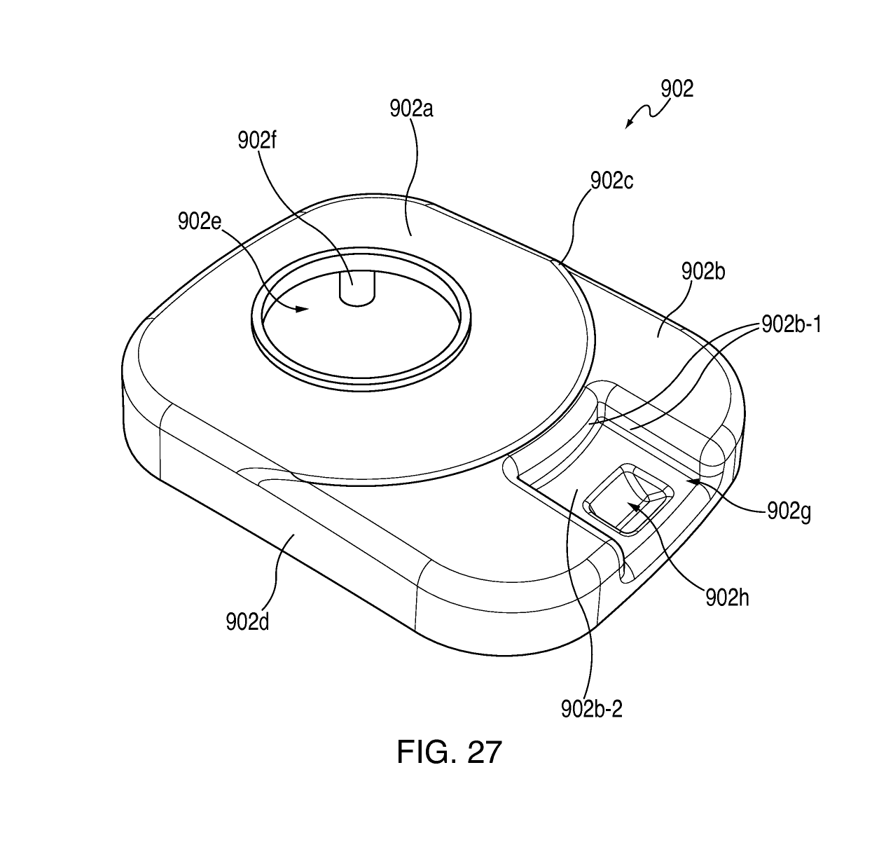

Housing 700 of FIG. 23 may include upper housing portion 702, which may be substantially similar to upper housing portion 102 of housing 100, with the exception that the former may include recess 704. Recess 704 may store arm 710 therein, which may allow a user to rotate gears stored within housing 700 by performing a pumping motion to arm 710. In some embodiments, arm 710 may be referred to as a crank. When a user intends to use arm 710, the user may lift arm 710 in the direction of arrow 706 to a flipped position, and then return arm 710 back to its original position. This “pumping” action may cause gears stored within housing 700 to rotate, thus generating heat in one or more heating elements coupled thereto.

In some embodiments, a user may, instead, flip arm 710 into a reversed position (signified by the dashed lines) by lifting arm 710 in the direction of arrow 706. After arm 710 has been placed into the reversed position, a user may rotate arm 710 about base member 708. This may enable base member 708 to rotate, which in some embodiments may be coupled to one or more gears stored within housing 700. Rotating of the one or more gears may, therefore, generate heat within one or more heating elements coupled to the gears stored within housing 700. In some embodiments, rotating of base member 703 to generate heat by rotating gears stored within housing 700 may be substantially similar to generation of heat via rotation of rotating arm 108 about base member 110 of housing 100, and the previous description may apply.

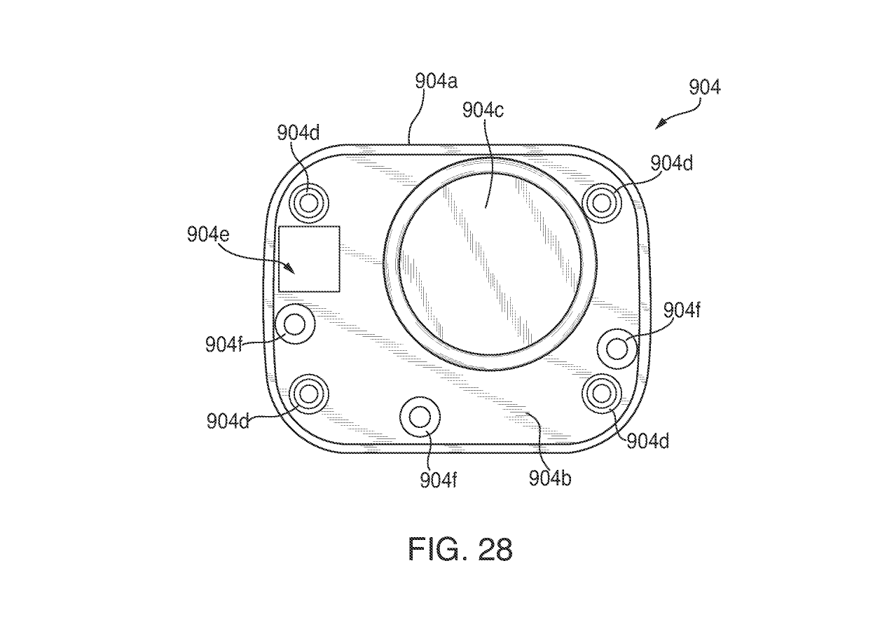

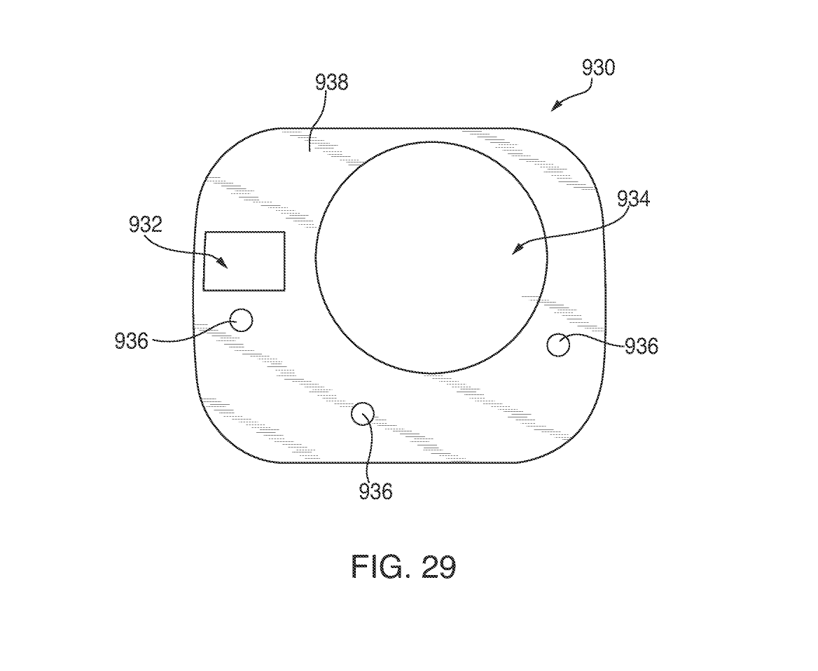

Housings structure 800 and 850 of FIGS. 24 and 25, respectively, may each include upper housing portion 802 and lower housing portion 804. Upper and lower housing portions 802 and 804 are, in some embodiments, substantially similar to upper and lower housing portions 102 and 104 of housing 100, with the exception that the later may include groove 818 located in upper housing section 802. Groove 818 may enable an outer portion 812 of rotating arm 808 to rotate about base member 810. Outer portion 812 of rotating arm 806 may be recessed into groove 818 such that tab member 816, when folded down, may be stored within opening 814. Thus, in the storing configuration, housing 800 may be substantially contained within the boundaries of upper and lower housing portions 802 and 804.

In some embodiments, a user may flip tab member 816 upwards such that a use may apply a force F to tab member 816. By applying force F to tab member 816, rotating arm 806 may rotate in a direction R about base member 810. This may cause one or more gears (e.g., gears 202, 204, 206, and 224) stored within housing 800, and coupled to base member 810, to rotate. In some embodiments, as described above, rotation of one or more gears within housing 800 may cause heat to be generated within one or more heating elements coupled to the gears stored within housing 800.

Housing 800 and 850 are, in some embodiments, substantially similar with the exception that housing tab member 816 may have a first orientation in housing 800, and a second orientation in housing 850. For example, in housing the first orientation, tab member 816 may be capable of being stored within opening 814, which may be positioned substantially parallel to the direction of force F. Thus, when rotating arm 808 rotates about base member 810, a length of opening 814 also rotates in an axis that may be substantially parallel to the direction of force F. In the second orientation, opening 814 may be positioned substantially perpendicular to force F. In this scenario, when rotating arm 808 rotates about base member 810, opening 814 also rotates along in a substantially same direction, however the length of opening 814 remains substantially perpendicular to the direction of force F.

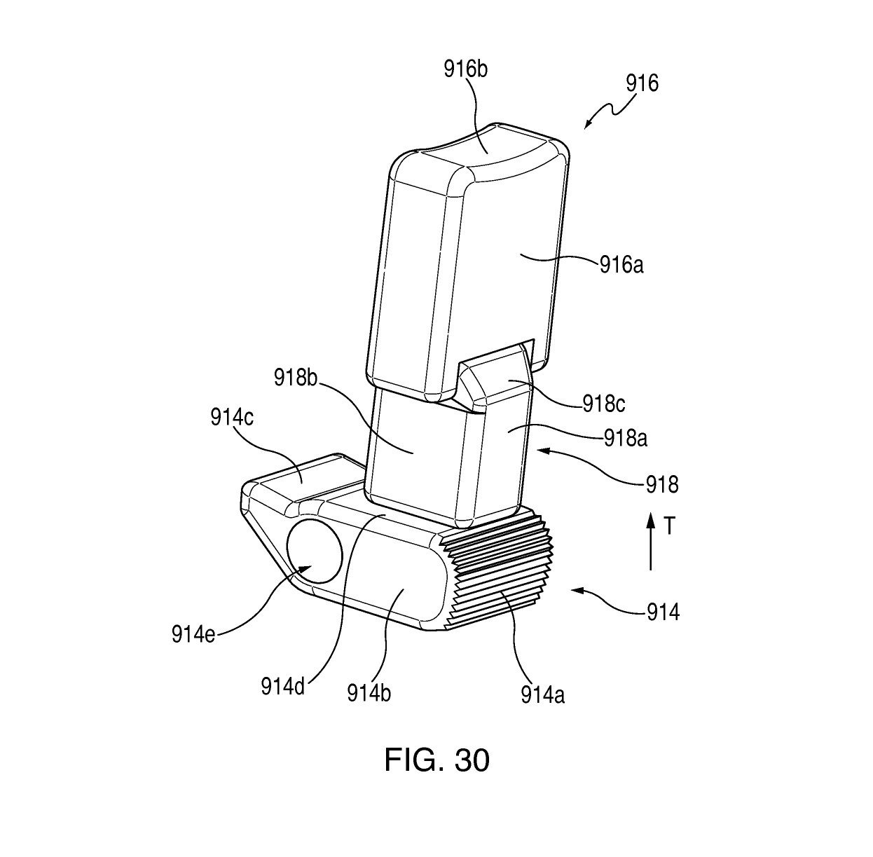

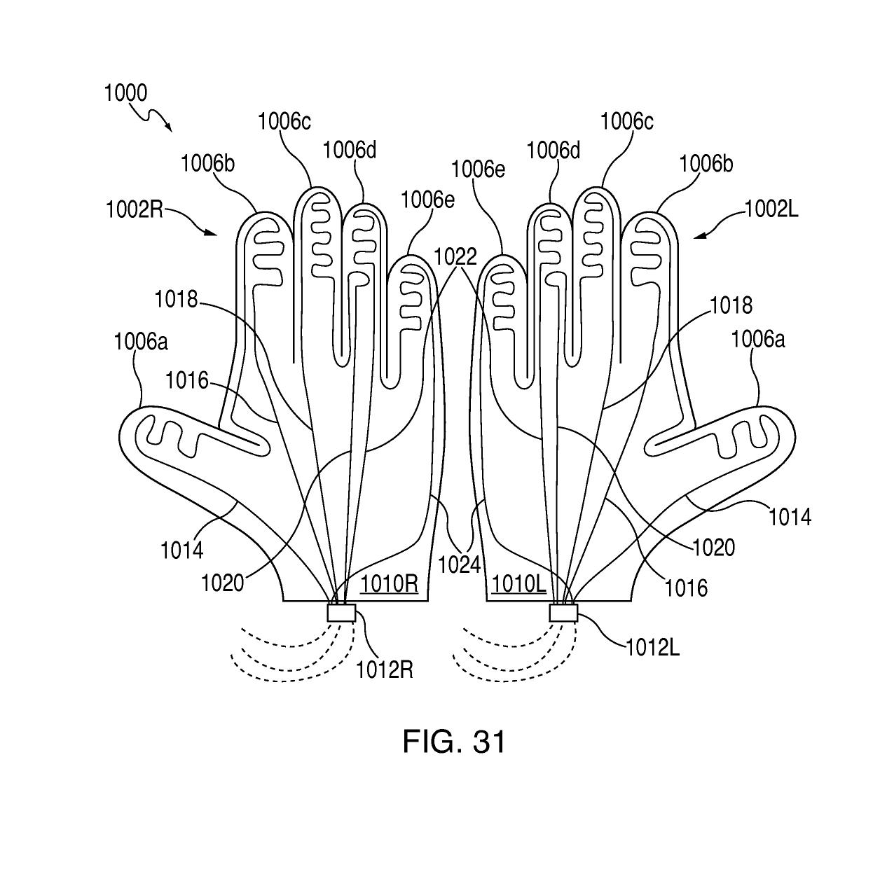

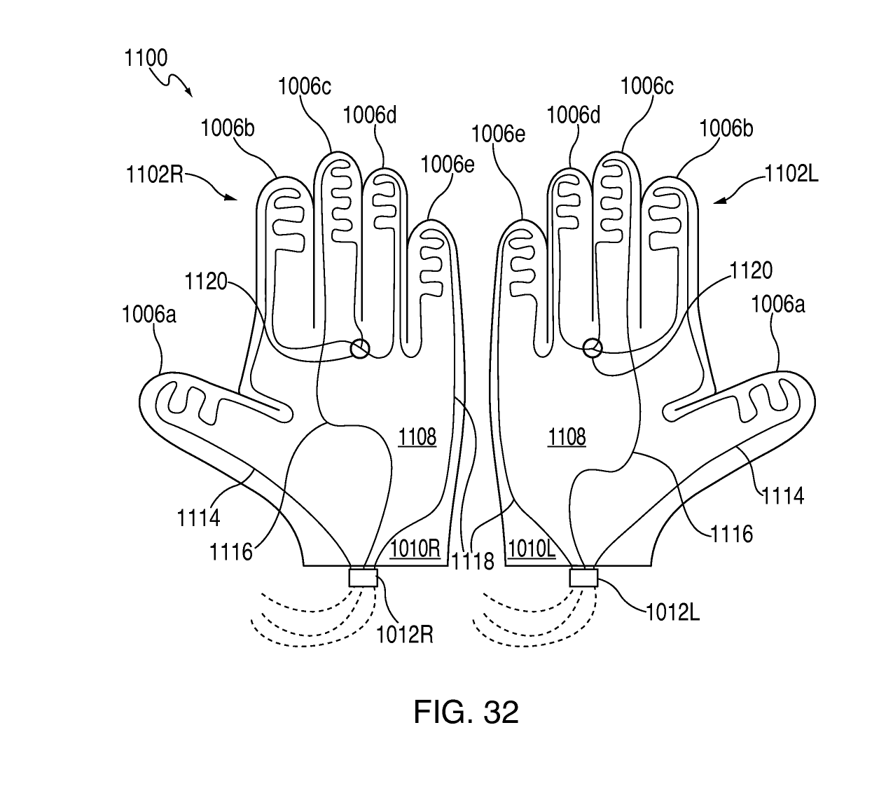

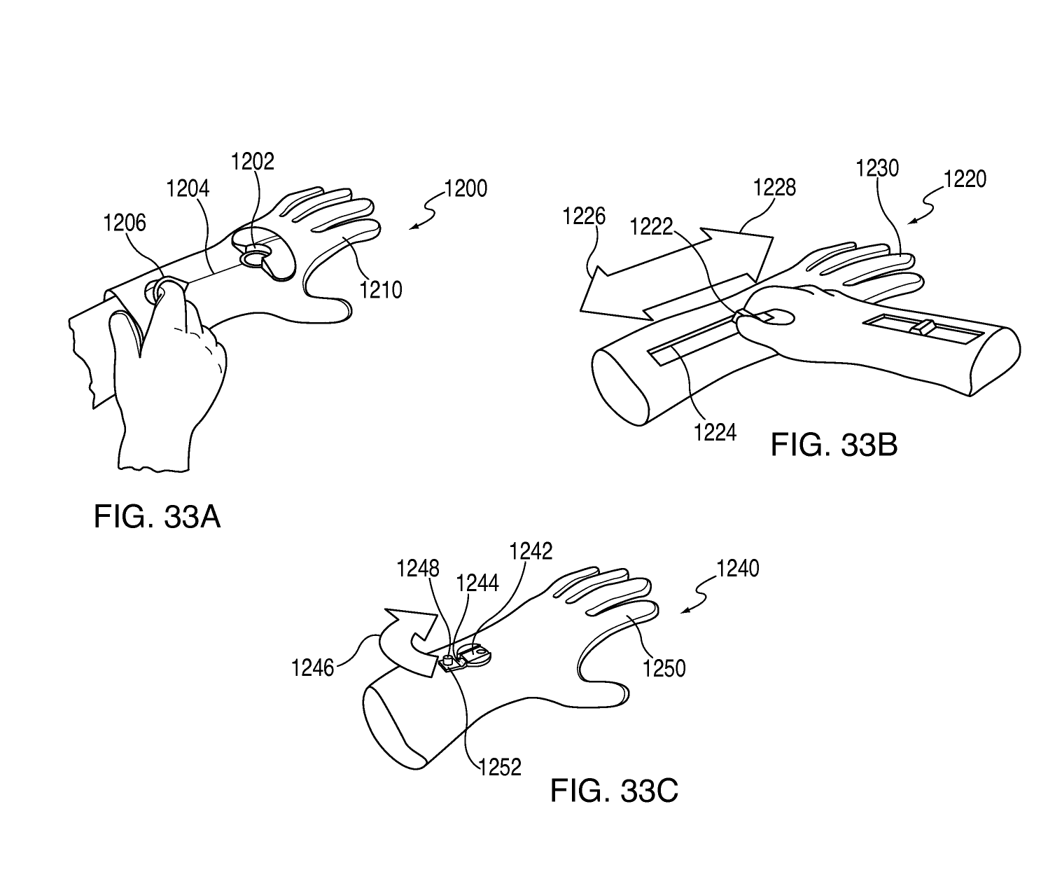

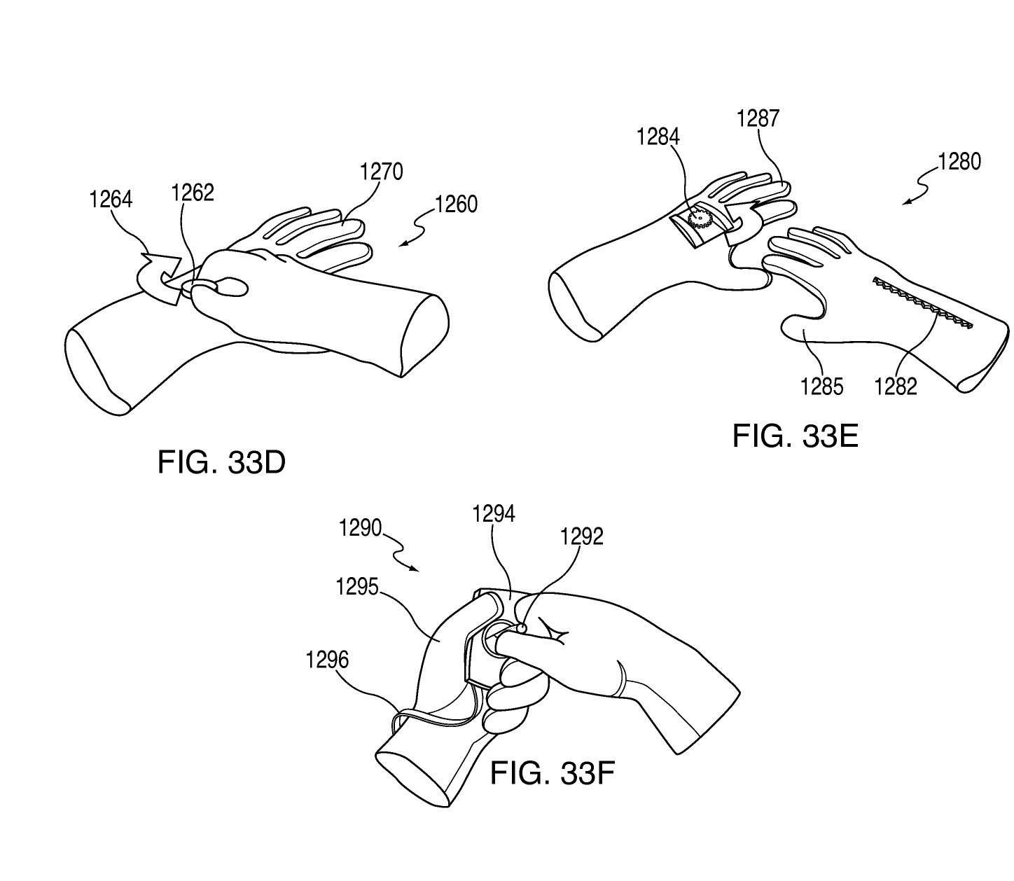

FIG. 26-30 are illustrative diagrams of another exemplary micro-generator housing and its components in accordance with various embodiments. Micro-generator housing 900, in some embodiments, includes upper housing portion 902, lower housing portion 904, and supporting base plate 930. In some embodiments, one or more gears and micro-alternators of a micro-generator, such as gears 202, 204, 206, and 224, may be stored within upper and lower housing portions 902 and 904. Housing 900, furthermore, may also be integrated or attached to one or more heating elements associated with, or integrated into, an article of clothing. For example, glove 2 of FIG. 1A may include micro-generator housing 900 instead of micro-generator housing 100. In this way, a user may use micro-generator housing 900 to generate heat to various portions of glove 2.

Upper housing portion 902 may include first section 902a and second section 902b, which may be separated by circular ridge 902c. First section 902a may include opening 902e, which may have a portion of rotating base member 110 extending there through. This may enable rotating base member 110 to couple to one or more gears within micro-generator 200 so that a user may generator energy using by micro-generator 200 by manually rotating arm 108 about base member 110. Second section 902b, in some embodiments, may include recess 902g, which may be located at a front end of second section 902b. Recess 902g may include three (3) side walls 902b-1, which may define recess 902g. In some embodiments, recess 902g may also include another recess 902h therein. Both recesses 902g and 902h may be depressed within a planar surface of upper housing portion 902 such that recesses 902g and 902h may be lower than first section 902a. This may enable various portions of tab member 916 to be stored on upper housing portion 902 when rotating arm 908 is not in use. In some embodiments, recess 902g may include substantially planar portion 902b-2 which may be substantially parallel to first section 902a and parts of second section 902b, however planar portion 902b-2, as mentioned above, may be slightly lower in height.

Extending downwards and away from a planar surface of first section 902a and parts of second section 902b may be walls 902d. Walls 902d may form a substantially right angle with the planar portions of upper housing portion 902b, and may be capable of enclosing micro-generator 200 within housing 900 when engaged with lower housing section 904. Upper housing portion 902b may also include support bars 902f extending downward toward openings 904d-2 of lower housing portion 904 to enable upper housing section 902 and lower housing section 904 to be coupled together. In some embodiments, support bars 902f may extend downwards such that they substantially abut openings 904d. For example, when upper housing portion 902 is placed on top of lower housing 904, support bars 902f may contact openings 904d.

Lower housing portion 904 may include side walls 904a, which may extend upwards and engage with side walls 902d of upper housing portion 902. In some embodiments, lower housing portion 904, as well as upper housing portion 902, may be substantially rectangular in shape. For example, side walls 904a may extend about a perimeter of substantially rectangular shaped lower housing section 904, while base 904b may extend about an area formed within the perimeter formed by walls 904a.

Located slightly off-center from base 904b may be cavity 920, having a substantially planar base 904c. Cavity 920, in some embodiments, may be substantially circular, however persons of ordinary skill in the art will recognize other shapes and configurations may be used. In some embodiments, cavity 920 may be configured such that rotating alternator housing 208 may fit therein. For example, when micro-generator 200 is placed within housing 900, rotating alternator housing 208 may be positioned within cavity 920.

Lower housing portion 904 may also include openings 904f. Openings 904f, in some embodiments, may enable lower housing portion 904 to be coupled to supporting base plate 930. For example, one or more screws or coupling mechanisms may be inserted through opening 904f of lower housing portion 904 and openings 936 of supporting base plate 930, thereby coupling lower housing portion 904 and supporting base plate 930 together.

Lower housing portion 904 may also include, at a front end, opening 904e. Opening 904e may allow access to one or more components of micro-generator 200. For example, one or more contacts of printed circuit board 228 may be accessible is opening 904e of lower housing portion 904. This may enable one or more heating elements for an article of clothing, such as glove 2, to be coupled to micro-generator 200 stored within housing 200, thereby enabling energy produced by rotation of rotating arm 108, and thereby gears 202, 204, 206, and 224, to generate energy within a micro-alternator stored within rotating alternator housing 208. The energy may then be communicated from micro-generator 200 to the one or more heating elements of the article or clothing via a connection formed with printed circuit board 228, via opening 904e.

Supporting base plate 930 may, in some embodiments, be used to attach micro-generator housing 900 to a portion of an article of clothing, such as glove 2. For example, supporting base plate 930 may be integrated into a support cuff located on a wrist portion of glove 2. Supporting base plate 930 may serve a multitude of functions. For example, supporting base plate 930 may provide structural support for housing 930 such that it stays substantially rigid when being used. As another example, supporting base plate 930 may provide protection to a user. For example, supporting base plate 930 may be capable of protecting a user from injury if housing 900 is, accidently, pushed into a user. For example, a user wearing glove 2 including micro-generator 200 stored within micro-generator housing 900, may, accidently, fall and strike the ground with the portion of glove 2 including micro-generator housing 900. In one exemplary scenario, supporting base plate 930 may ensure that micro-generator housing 900 is not compressed between the ground and the user's wrist, such that micro-generator housing 900 does not causes damage to the user. Similarly, supporting base plate 930 may also serve to protect micro-generator housing 900 from being damaged by a user when such an accidental fall or erroneous movement occurs. For example, in the same way that micro-generator housing may be pushed into a user's wrist or arm, a user's wrist or arm may, in turn, push into micro-generator housing 900. Supporting base plate 930, in some embodiments, serves to protect housing 900 so that the force exerted by the user's wrist or arm does not damage housing 900 and micro-generator 200 stored therein.

Supporting base plate 930, in some embodiments, includes openings 932, 934, and 936. Each of openings 932, 934, and 936 may be located within substantially planar base portion 938 of supporting base plate 930. Opening 934 may be capable of receiving a portion of cavity 904c of lower housing portion 904. For example, when micro-generator housing 900 is formed with supporting base plate 930, cavity 920 may extend through opening 934. However, in another embodiment, cavity 920 may not extend completely though opening 934, as supporting base plate 930 may be located below lower housing portion 904 such that the distance between base 938 and a lower surface of lower housing portion 904 are separated by substantially the height of cavity 920. Opening 934 may also be of any suitable shape and size such that it may receive cavity 920 when formed with housing 900. Supporting base plate 930 also may include opening 932, which may enable a user to connect one or more heating elements located within the article of clothing to printed circuit board 228. For example, one or more connectors or connecting elements may extend from the article of clothing through opening 932 and through opening 904e to one or more contacts of printed circuit board 228. However, in some embodiments, supporting base plate 930 may not include opening 932 for facilitating connection between the one or more heating elements and printed circuit board 228, as the one or more heating elements may couple to printed circuit board 228 via opening 904e within lower housing portion 904.

Housing 900 may also include first tab member 916 and second tab member 914. First and second tab members 916 and 914 may function in a substantially similar manner as tab members 330 and 316 of housing 300, with the exception that the former may be configured in a slightly different manner. In some embodiments, first tab member 916 may include outer surface 916a, which may be substantially rectangular in shape. A user may apply a force to outer surface 916a which may cause rotating arm 108 to rotate about rotating base member 110. Tab member 916 may also include side walls 916b, which may define a thickness of tab member 916. For example, in some embodiments, side walls 916b may be a substantially same thickness as a height of side walls 902b-1 of upper housing portion 902. This may enable tab member 916 to fit within recess 902g when tab member 916 is stored therein.

Coupled to first tab member 916, in some embodiments, may be connector piece 918. Connector piece 918 may couple tab member 916 and tab member 914 together. Connector piece 918, in some embodiments, in substantially box shaped, and includes a first side 918a and a second side 918b. In some embodiments, first side 918a and second side 918b may be such that connector piece 918 fits within recess 312f of slide 312.

In some embodiments, tab member 914 may be connected to connector piece 918 such that a substantially right angle is formed between tab member 914 and connector piece 918. Tab member 914 may, in some embodiments, include ridged portion 914a, central portion 914b, and angled portion 914c. Ridged portion 914a may be located proximate connector piece 918. Ridged portion 914a may be curved and may include a plurality of ridges or raised bumps that provide a tactile surface for a user to touch. The plurality of ridges within ridge portion 914a may provide friction between a user's fingers and ridge portion 914a such that a user may cause tab members 914 and 916 to rotate about a longitudinal axis of pin 340 that may extend through openings 914e and 312e. For example, in a first configuration, as seen in FIG. 26, tab members 914 and 916 may be oriented such that a user may provide a force to tab member 916, which may cause rotating arm 108 to rotate about base member 110, as described in greater detail above. In a second configuration, tab member 916 may be folded into slide 312, as described above. This may occur by a user providing a force T along ridge portion 914a. By applying force T to ridge portion 914a with enough frictional force felt on ridge portion 914a, tab member 914 may rotate about an axis of pin 340, inserted into openings 914e and 312e, which may cause tab member 916 to rotate downwards into the opening formed between second section 312b of slide 312, as well as causing connector portion to rotate downwards into recess 312f. Thus, ridge portion 914a provides a convenient and ergonomically way to store tab members 914 and 916 within housing 900, while easily enabling tab members 914 and 916 to be used to cause rotating arm 108 to rotate, and thus produce a heating effect in the one or more heating elements coupled to micro-generator 200.

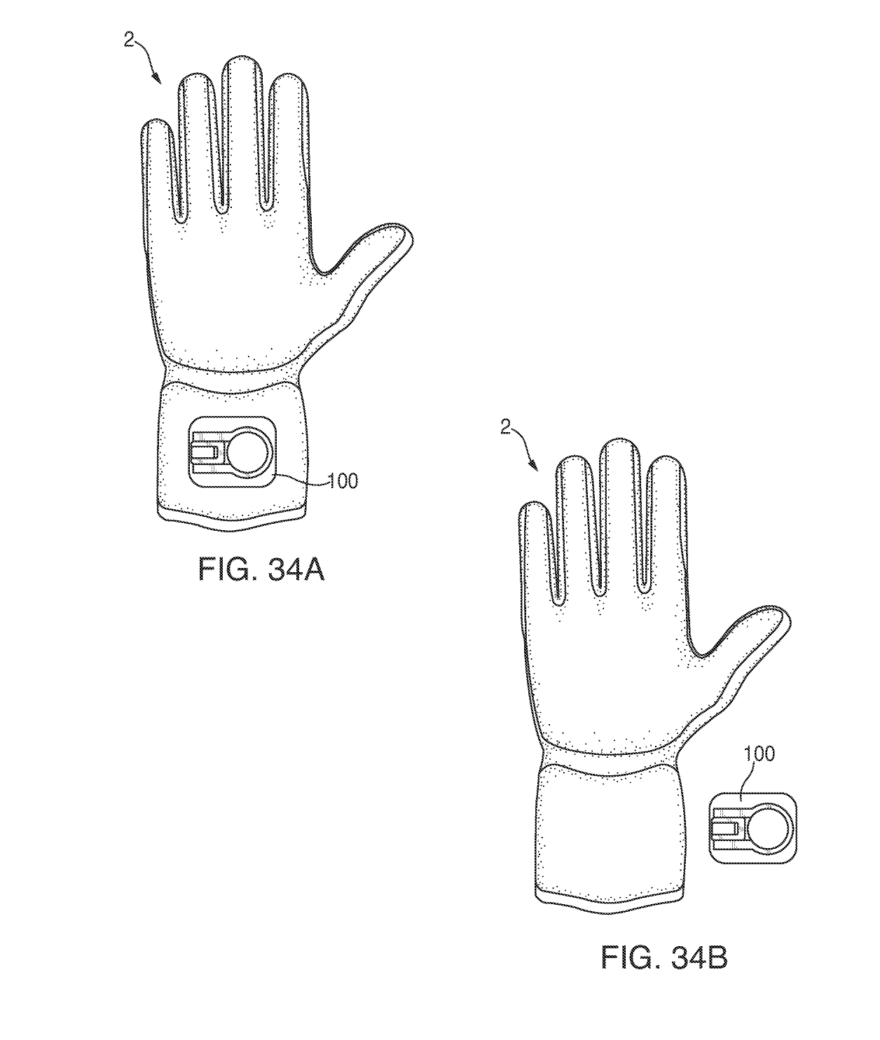

FIG. 31 is an illustrative diagram of an exemplary heating element configuration in accordance with various embodiments. Heating element configuration 1000, in some embodiments, may be referred to as a delta layout. A delta layout, as used herein, may refer to a single wire, a single conductive element, and/or a single heating element configuration. Heating element configuration 1000 as shown, refers to one exemplary embodiment corresponding to a right glove 1002R and a left glove 1002L, which may be substantially similar to glove 2 of FIG. 1A. However, persons of ordinary skill in the art will recognize that other articles of clothing may be used with heating element configuration 1000 including, but not limited to, hats, shoes, boots, socks, jackets, shirts, undergarments, vests, and/or scarves. For example, heating element configuration 1000 may be used with sock 40 of FIG. 1B and/or shirt 40 of FIG. 1C.

Each of gloves 1002R and 1002L may include a thumb portion 1006a, a pointer finger portion 1006b, a middle finger portion 1006c, a ring finger portion 1006d, and a pinky finger portion 1006e, as well as wrist portions 1010R and 1010L. In some embodiments, portions 1006a-e and 1010a and 1010b may be substantially similar to portions 6a-e and 10a and 10b of glove 2, and the previous description may apply. However, persons of ordinary skill in the art will recognize that, in some embodiments, gloves 1002R and/or 1002L may include fewer or more portions. For example, in some embodiments, gloves 1002R and 1002L may each include a thumb portion and then a finger portion, where the finger portion may cover multiple fingers (e.g., a mitten).

Each portion of gloves 1002R and 1002L may include heating elements that extend through each finger portion. In the exemplary heating element configuration 1000, the various heating elements may correspond to a single wire or heating element. For example, a single heating element may extend from a connector 1012R or 1012L to the various finger portions. In one illustrative embodiment, a first heating element portion 1014 may extend from connector 1012R (e.g., from wrist portions 1010R, 1010L across a palm portion) to thumb portion 1006a and then to pointer finger portion 1006b. A second heating element portion 1016 of the heating element may then return from pointer finger portion 1006b to connector 1012R, 1012L. Then, a third heating element portion 1018 of the heating element may extend from connector 1012R, 1012L to middle finger portion 1006c, and then to ring finger 1006d. A fourth heating element portion 1020 of the heating element may then return from finger portion 1006d to connector 1012R, 1012L. Finally, a fifth beating element portion 1022 may extend from connector 1012R, 1012L to pinky finger portion 1006e, and then return via a sixth heating element portion 1024 to connector 1012R, 1012L.

The heating elements in configuration 1000 may be made of one wire, conductive yarn, or any other type of heating element and may be coupled to, or integrated into, the article of clothing (e.g., glove 1002R, 1002L). In some embodiments, the heating element or wire may be a conductive yarn or other fabric including conductive particles or filaments. For example, the heating element may be a stainless steel yarn having a diameter between 0.2 and 0.5 mm, and a resistivity of approximately 9 Ohms/meter. However, persons of ordinary skill in the art will recognize that, as used herein, a conductive yarn may correspond to a single yarn having conductive particulate distributed throughout the yarn, multiple non-conductive threads and conductive threads woven together into a single yarn, a string-like object made of a conductive material such as steel or copper, or any other type of conductive yarn-like material.

In some embodiments, connectors 1012R and 1012L may connect to micro-generator 200 via printed circuit board 228, as described above. In one illustrative example, micro-generator 200 may produce three-phase alternating current (“AC”) power. For a delta configuration where the heating element (e.g., wire) may have a resistance of approximately 12 Ohms, a rotational speed of rotating arm 108 of approximately 2400 RPMs may produce approximately 7 Watts of power. However, persons of ordinary skill in the art will recognize that the aforementioned values are merely exemplary.

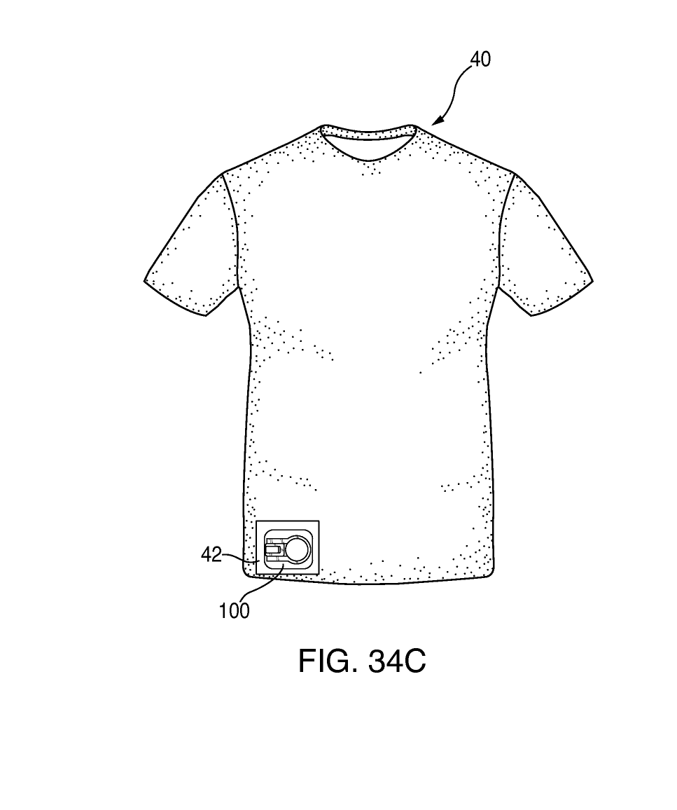

FIG. 32 is an illustrative diagram of another exemplary heating element configuration in accordance with various embodiments. Heating element configuration 1100 may, in some embodiments, correspond to a three wire configuration, which may be referred to as a “Wye” configuration. Heating element configuration 1100 may be substantially similar to heating element configuration 1000, with the exception that the former may include three heating elements, or wires, 1114, 1116, and 1118.

In some embodiments, heating element 1114 may extend from connector 1012R, 1012L (e.g., from wrist portion 1010R, 1010L, and through a palm portion) to thumb portion 1006a. Heating element may then extend about the perimeter of thumb portion 1006a to pointer finger portion 1006b, and then to junction point 1120. Heating element 1116 may extend from connector 1012R, 1012L to middle finger portion 1006c and then to junction point 1120. Heating element 1118 may extend from connector 1012R, 1012L to pinky finger portion 1006e to ring finger portion 1006d and then to junction 1120.

As seen in both heating element configurations 1000 and 1100, the various heating elements may be incorporated into gloves 1002R, 1002L, and 1102R, 1102L in any suitable fashion. In some embodiments, the various heating elements may include a ridged or woven portion proximate a distal end of each finger portion. For example, as seen in thumb portion 1006a, heating element 1014 and 1114 both extend along thumb portion 1006a until reach the distal end of thumb portion 1006a (e.g., opposite the portion of thumb portion 1006a that is proximate to a palm portion or wrist portion). At the distal end, heating element 1014 and/or 1114 may loop around thumb portion 1006a, be inserted such that heating element 1014 and/or 1114 forms a toothed pattern, or have any other suitable configuration or pattern. This may enable heating element 1014 and/or 1114 to apply a greater amount of heat to a greater area of coverage by thumb portion 1006a due to the increased density of heating element 1014 and/or 1114 in that portion of thumb portion 1006a. A similar effect may be used for each additional finger portion 1006b-e, and/or for any other section of gloves 1002R, 1002L and/or 1102R, 1102L, and the description for thumb portion 1006a is merely illustrative.

In some embodiments, heating elements 1014-1024 and/or 1114-1120 may be integrated into an article of clothing that will be used with a micro-generator, such as micro-generator 200, to allow a user to manually generate heat in that article of clothing. For example, gloves 1002R, 1002L may have heating elements 1014-1024 integrated therein to enable a user to manually generate heat within gloves 1002R, 1002L using a micro-generator, such as micro-generator 200. Various techniques may be used to integrate heating elements 1014-1024 and/or 1114-1120 into the article of clothing including, but not limited to, embroidering, sewing, an adhesive, or any other coupling mechanism, or any combination thereof. In some embodiments, the article of clothing may be formed of a material including conductive fibers such as those used to form heating elements 1014-1024 and/or 1114-1120. For example, one or more layers of the article of clothing may be stitched together using the heating element materials (e.g., conductive fibers). In some embodiments, the article of clothing may be formed of multiple layers, and the heating elements may be placed between two of the layers. For example, the article of clothing may be a glove, and the glove may include an outer leather layer, and inner layer, and one or more intermediate layers between the inner layer and the outer leather layer. In this particular scenario, the heating elements may be stitched into, or in between one of the intermediate layers, and or between an intermediate layer and one of the inner and outer leather layer. Persons of ordinary skill in the art will recognize that any other process may be used to integrate the heating elements into the article, and the heating elements may have any suitable pattern when integrated into the article, and the aforementioned is merely exemplary.

For example, in one illustrative embodiment, heating elements 1014-1024 and/or 1114-1120 may be stitched to a base layer including a stitched outline of gloves 1002R and 1002L. The base layer including heating elements 1014-1024 and/or 1114-1120 stitched thereto may then be sewn into an intermediate layer of gloves 1002R and 1002L, and another intermediate layer may be stitched onto an opposing side of the base layer such that the base layer is encased by the two intermediate layers. However, in some embodiments, no intermediate layers may be used and the base layer may be stitched to an exterior or outer layer (albeit an inner portion of the exterior or outer layer). Persons of ordinary skill in the art will recognize that although the aforementioned technique may be used for forming gloves 1002R and 1002L, a similar technique may be used for forming any other article of clothing, such as sock 20 and/or shirt 40.

In some embodiments, micro-generator 200 may be a three-phase micro-generator, and heating elements 1014-1024 and/or 1114-1120 may couple to micro-generator 200 (e.g., via printed circuit board 228 and/or connectors 1012R, 1012L) to output the power from micro-generator 200 to heating elements 1014-1024 and/or 1114-1120. In some embodiments, micro-generator 200 may include three sets of stators, which may each be offset from one another. The offset may allow the magnetic field created by the rotation about the stators to produce a three-phase current where the three phases are each displaced by a third of a period with respect to one another.

Heating elements 1014-1024 and/or 1114-1120 may, in some embodiments, be one or more wires, conductive yarns, or any other conductive elements that may allow power generated by micro-generator 200 to be passed from generator 200 thereto. For example, the heating elements 1014-1024 may connect micro-generator 200 to heat a portion of glove 1002R, 1002L. In this scenario, rotation of gears 202, 204, 206, and/or 224, for example, of micro-generator 200 may cause power to be sent to heating elements 1014-1024, producing heat in those areas of gloves 1002R and 1002L where heating elements 1014-1024 are located.

In some embodiments, a voltage drop may occur at heating elements 1014-1024 and/or 1114-1120 receiving power from micro-generator 200. The voltage drop may correspond to an amount of voltage deposited or used by a heating element (e.g., heating elements 1014-1024), which may correspond to each heating element's intrinsic resistance and an amount of current passing through each heating element.

The energy deposited from the voltage drop may eventually dissipate. The amount of time or the form of the dissipation may also vary. In some embodiments, the dissipation may be in the form of heat produced by each heating element where the voltage drop occurred. The heat dissipation should be configured such that heating element, which for illustrative purposes may function as a resistor, does not overheat and break down, and it should also be configured to limit the generated heat such that the user is not burned. Most resistors, for example, have an inherent power rating, which corresponds to a maximum amount of power the resistor may accept and still be able to dissipate heat properly without any damage. Thus, in some embodiments, a continuous or semi-continuous source of heat may be formed by providing power to various heating elements (e.g., resistor), such as heating elements 1014-1024 and/or 1114-1120.

In some embodiments, heating elements 1014-1024 and/or 1114-1124 may have resistive properties such that voltage drops, and thus heat dissipation, may occur along one or more points of heating elements 1014-1024 and/or 1114-1120. For example, the heating elements 1014-1024 and/or 1114-1120 may be graphite infused three-twist wires, and/or conductive filaments or yarns, which may have certain resistive features. These resistive features may correspond to an overall resistance ranging between 5 and 10 Ohms, however persons of ordinary skill in the art will recognize that any resistance value may be associated with the one or more heating elements, and the resistance may vary for each heating element and/or may vary along a length of the heating element.

The one or more heating elements connected to housing micro-generator 200 may, in some embodiments, be interwoven or integrated into an article of clothing. For example, the one or more wires may be integrated into the lining of a glove, a hat, shoes, socks, jackets, or any other article of clothing. As a particular example, heated gloves having a three-phase micro-generator incorporated into a portion of one or both of the gloves may have graphite infused wires running through the glove to the glove's fingertips. In this way, in response to actuation of the gears of the generator, power may be sent through the wires, which may in turn dissipate heat. However, persons of ordinary skill in the art will recognize that other methods of dissipating heat through an article of clothing may be used including, but not limited to, conductive liners, one or more resistors placed at specific locations, and/or wires with varying resistive properties.

In some embodiments, the power outputted by the three-phase micro-generator may be set such that for a certain resistive element, a specific amount of heat will be generated. For example, for a 7 Ohm wire, approximately 7 Watts of power may produce approximately 40-degrees Fahrenheit temperature difference between the temperature inside the gloves and the ambient outside temperature after 1.5 hours. As another example, a 6 Ohm wire having approximately 7.5 Watts of power applied to, may produce a temperature difference of about 25-degrees Fahrenheit after 1.5 hours.

In some embodiments, the rotational velocity may be provided using a rotating arm attached to the generator (e.g., rotating arm 108). However, in other embodiments, a pulley or load spring may be used as a mechanical input to rotate the generator.

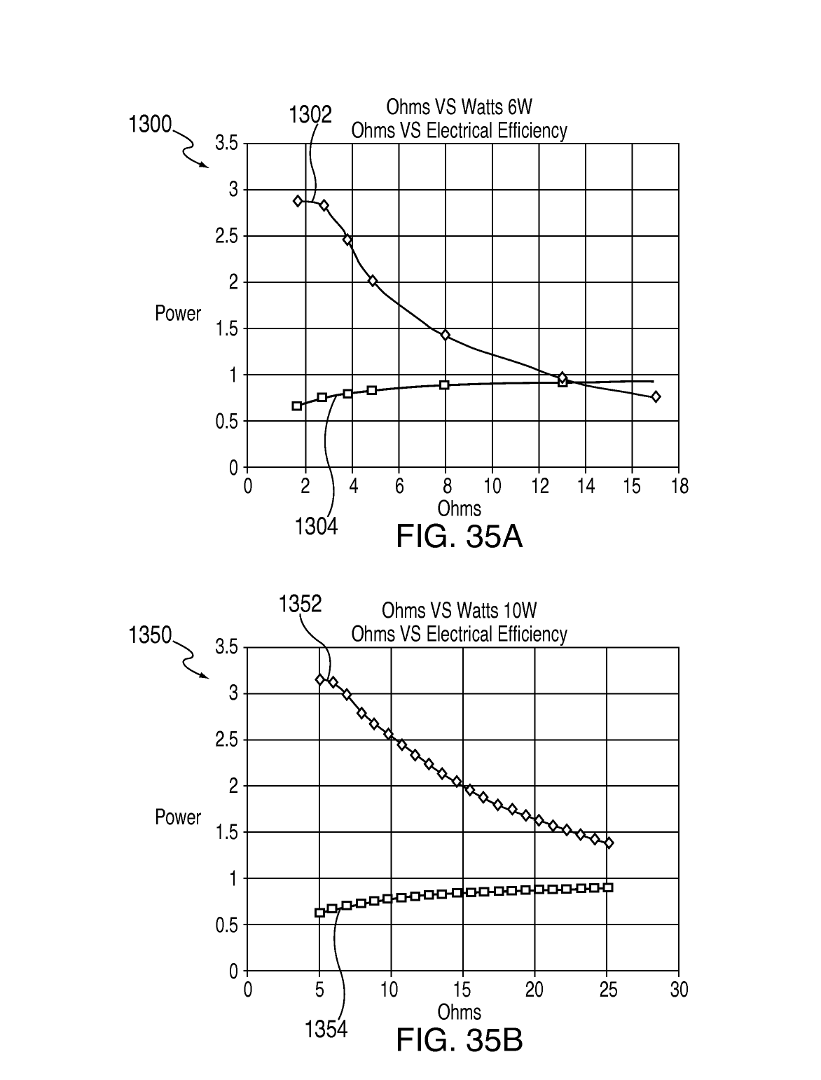

FIGS. 33A-F are illustrative figures of various configurations for a three-phase micro-generator incorporated into a glove in accordance with various embodiments. FIG. 33A is an illustrative figure of one embodiment of a micro-generator incorporated into a glove. Generator system 1200 of FIG. 33A may correspond to a micro-generator using an individual pulley mechanism with a clutch. System 1200 may include base 1202, pulley cord 1204, and pulley end member 1206. A user may generate a rotation in a micro-generator (e.g., micro-generator 200) built into glove 1210 by pulling pulley end member 1206 in a direction away from the glove's fingers, thereby causing a pulley cord to translate is linear motion to the generator's gears. Table 1 describes various gear ratio's for micro-generator 200 of system 1200 versus a pulley diameter for pull cord 204, operable to produce approximately 7 Watts of power for various parameters.

TABLE 1

| | Pulley Torque | | Pull Diameter |
|---|---|---|---|
| Gear Ratio | (Foot *Pounds) | Pulley RPS | (inch) |
| 25 | 0.411 | 2.00 | 1.409 |
| 24 | 0.395 | 2.08 | 1.353 |
| 23 | 0.378 | 2.17 | 1.297 |
| 22 | 0.362 | 2.27 | 1.240 |
| 21 | 0.345 | 2.38 | 1.184 |
| 20 | 0.329 | 2.50 | 1.128 |
| 19 | 0.312 | 2.63 | 1.071 |
| 18 | 0.296 | 2.78 | 1.015 |
| 17 | 0.280 | 2.94 | 0.957 |
| 16 | 0.263 | 3.13 | 0.902 |
| 15 | 0.247 | 3.33 | 0.846 |
| 14 | 0.230 | 3.57 | 0.789 |
| 13 | 0.214 | 3.85 | 0.733 |
| 12 | 0.197 | 4.17 | 0.677 |
| 11 | 0.181 | 4.55 | 0.620 |
| 10 | 0.164 | 5.00 | 0.564 |
| 9 | 0.148 | 5.56 | 0.507 |
| 8 | 0.132 | 6.25 | 0.451 |
| 7 | 0.115 | 7.14 | 0.395 |
| 6 | 0.099 | 8.33 | 0.338 |
| 5 | 0.082 | 10.00 | 0.282 |
| 4 | 0.066 | 12.50 | 0.226 |
| 3 | 0.049 | 16.67 | 0.169 |
| 2 | 0.033 | 25.00 | 0.113 |
| 1 | 0.016 | 50.00 | 0.056 |

FIG. 33B is an illustrative figure of another embodiment of a micro-generator incorporated into a glove. Generator system 1220 of FIG. 33B may include spring member 1222, which may be coupled to a spring incorporated within glove 1230. A user may pull or push spring member 1222 in first direction 1226 through spring channel 1224, which may extend or compress the spring, and then release spring member 1222 translating the stored kinetic energy in the spring to the micro-generator causing the gears of the micro-generator (e.g., micro-generator 200) to rotate. The pulling/pushing motion may translate energy stored in the spring into rotational motion of the gears in the micro-generator incorporated into glove 1230.

FIG. 33C is an illustrative figure of yet another embodiment of a micro-generator incorporated into a glove. Generator system 1240 of FIG. 33C may include rotating member 1242, which is connected to actuator arm 1246 via hinge 1244. Hinge 1244 may further enable actuator arm 1246 to fold into member 1242 for easy storage. Stopper 1248 may also be included into system 1240, and may allow arm 1246 to securely fit into member 1242 such that when the member is not in use the arm remains securely flush to member 1242. A user may be operable to lift arm 1246 out of member 1242 when the user desires to operate the generator. In some embodiments, a user may turn arm 1246 in direction 1252 to rotate member 1242, causing gears within a micro-generator incorporated into glove 1250 to rotate. Table 2 illustrates various configurations for system 1240 that may produce a power output of 7 Watts at 2 revolutions per second.

TABLE 2

| | | | Equivalent | |
|---|---|---|---|---|
| | | | Linear Force | Torque foot- |
| | | | pounds at 7 | pounds at 7 |
| | | Equivalent | Watts | Watts |
| Rotating Arm | Knob | Linear Feet | continuous | continuous |
| Length | Diameter | per second | rotating arm | rotating arm |
| (inches) | (inches) | at 2 RPS | 2 RPS | 2 RPS |
| 1.0 | 2.0 | 1.05 | 4.93 | 0.41 |
| 1.1 | 2.2 | 1.15 | 4.48 | 0.41 |
| 1.2 | 2.4 | 1.26 | 4.11 | 0.41 |
| 1.3 | 2.6 | 1.36 | 3.79 | 0.41 |
| 1.4 | 2.8 | 1.47 | 3.52 | 0.41 |
| 1.5 | 3.0 | 1.57 | 3.29 | 0.41 |
| 1.6 | 3.2 | 1.68 | 3.08 | 0.41 |
| 1.7 | 3.4 | 1.78 | 2.90 | 0.41 |
| 1.8 | 3.6 | 1.88 | 2.74 | 0.41 |
| 1.9 | 3.8 | 1.99 | 2.60 | 0.41 |
| 2.0 | 4.0 | 2.09 | 2.47 | 0.41 |
| 2.1 | 4.2 | 2.20 | 2.35 | 0.41 |
| 2.2 | 4.4 | 2.30 | 2.24 | 0.41 |
| 2.3 | 4.6 | 2.41 | 2.14 | 0.41 |
| 2.4 | 4.8 | 2.51 | 2.06 | 0.41 |
| 2.5 | 5.0 | 2.62 | 1.97 | 0.41 |
| 2.6 | 5.2 | 2.72 | 1.90 | 0.41 |
| 2.7 | 5.4 | 2.83 | 1.83 | 0.41 |
| 2.8 | 5.6 | 2.93 | 1.76 | 0.41 |
| 2.9 | 5.8 | 3.04 | 1.70 | 0.41 |
| 3.0 | 6.0 | 3.14 | 1.64 | 0.41 |

FIG. 33D is an illustrative figure of still yet another embodiment of a micro-generator incorporated into a glove. Generator system 1260 of FIG. 33D may include rotating member 1262, which may be incorporated into glove 1270. In some embodiments, a user may rotate member 1262 in direction 1264 creating a rotational motion of gears within a micro-generator incorporated into glove 1270.

FIG. 33E is an illustrative figure of another embodiment of a micro-generator incorporated into a glove. Generator system 1280 of FIG. 33E may include rack 1282 and pinion 1284. In some embodiments, rack 1282 may be incorporated into first glove 1285 of system 1280, and pinion 1284 may be incorporated into second glove 1287 of system 1280. A user may place the first glove and second glove in contact with one another such that teeth of rack 1282 and pinion 1284 interact with one another, generating a rotational motion of pinion 1284. In some embodiments, the rotational motion of pinion 1284 may be translated into rotational motion of gears within a micro-generator incorporated into glove 1287. Persons of ordinary skill in the art will recognize that micro-generators may be include in both gloves, and therefore each glove may include a rack and a pinion, and the illustrated embodiment is merely exemplary.

FIG. 33F is an illustrative figure of a further embodiment of a micro-generator incorporated into a glove. Generator system 1290 of FIG. 33F may include external member 1292 having actuator member 1294 protruding therefrom. A user may rotate member 1294, which may translate energy from gears within member 1292 to gears included within a micro-generator incorporated into glove 1296. In some embodiments, each glove may include a separate external member that is attached to its respective glove, such that the energy generated in the external gearbox is translated to that gloves corresponding micro-generator, thereby heating both gloves.

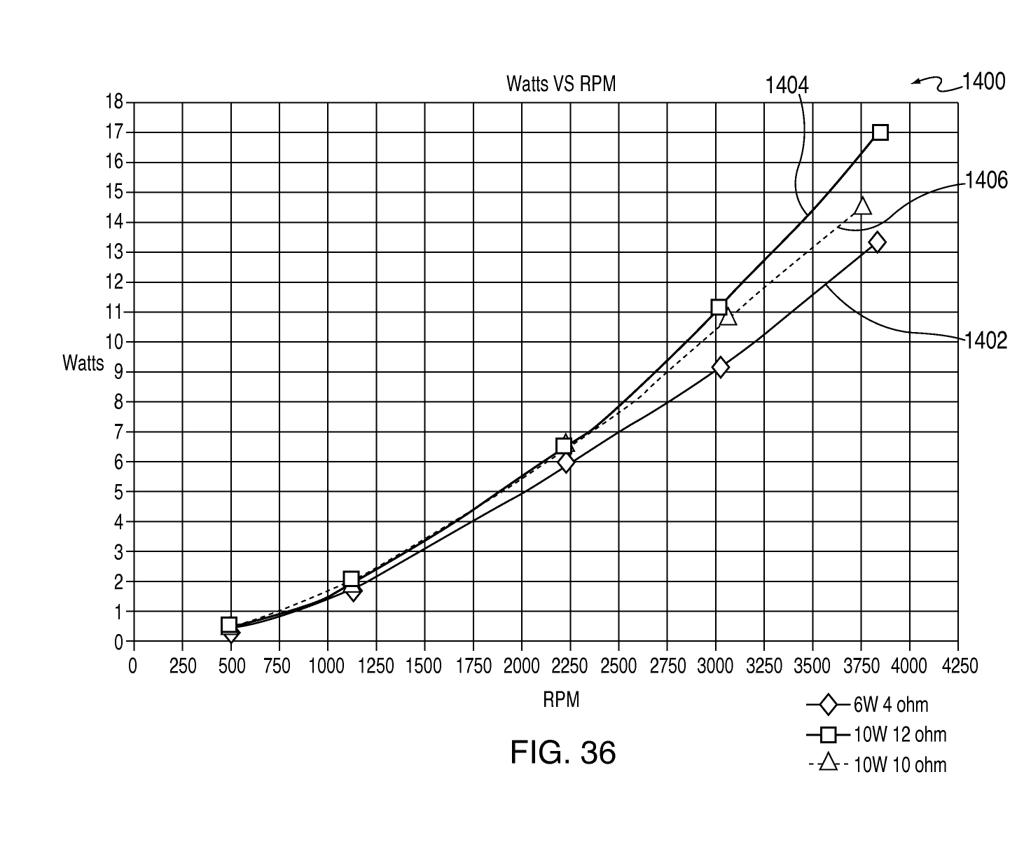

FIGS. 34A-C are illustrative diagrams of a system for using a micro-generator, such as the micro-generator of FIG. 7, to provide heat to various articles of clothing in accordance with various embodiments. As described above, glove 2 of FIG. 33A may include housing 100 having a micro-generator, such as micro-generator 200, stored therein. In some embodiments, housing 100 and the micro-generator stored therein may be removable from glove 2. For example, as seen in FIG. 33B, housing 100 including micro-generator 200 may be removed from glove 2 such that the two are separate units. Housing 100 and micro-generator 200 may then be coupled to another article of clothing, such as shirt 40, as seen in FIG. 33C. In some embodiments, housing 100 may couple to a connector pad or an area on shirt 40, such as area 42. Area 42 may include one or more connector ports, such as a male or female connector end, that may couple to a respective female or male connector end extending from micro-generator 200 through housing 100. For example, PCB 228 of FIG. 12 may be coupled to a connector, and this connector may be coupled to a corresponding connector on area 42 of shirt 40. In this way, an individual may use micro-generator 200 to warm various articles of clothing using a single micro-generator.

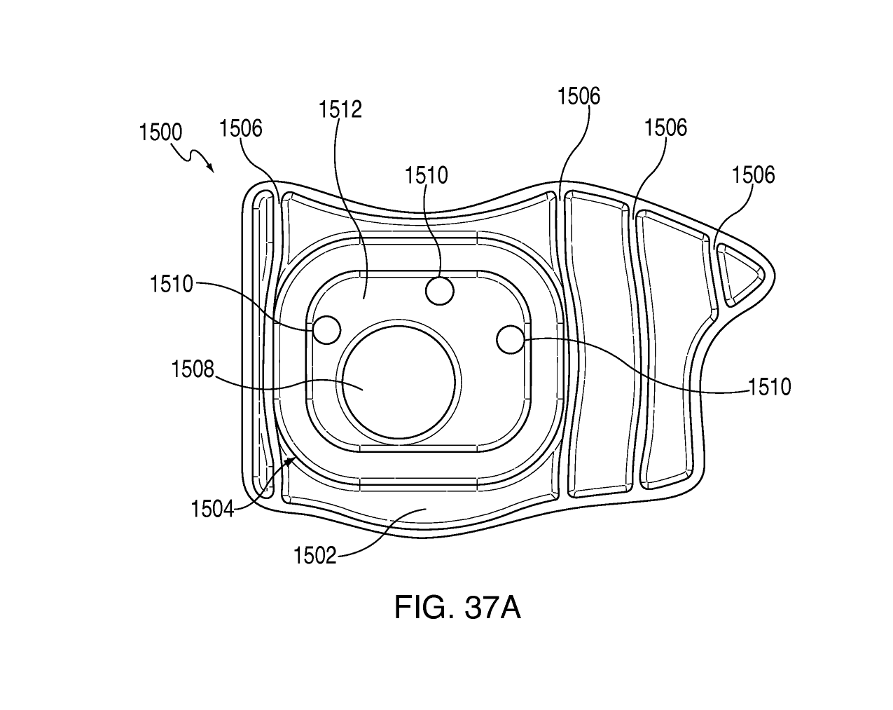

Graph 1300 of FIG. 35A may include resistance curve 1302 and efficiency curve 1304, and graph 1350 of FIG. 35B may include resistance curve 1352 and efficiency curve 1354. Curve 1302 may describe the 6 Watt micro-generator's resistance in comparison to power applied to the generator. For a three-phase micro-generator having a total power output of 7 Watts, each phase would need to be approximately 2.3 Watts. In graph 1300, this may correspond to approximately 4 Ohms, whereas for Graph 1350, this may correspond to approximately 12 Ohms. The electrical efficiency in both graphs 1300 and 1350, as seen from efficiency curves 1304 and 1354, is approximately 80% for 4 and 12 Ohms, respectively. The electrical efficiency may roughly correspond to an amount of energy lost due to resistance within the stator coil itself, however mechanical losses and environmental losses, for example, may also effect the electrical efficiency.

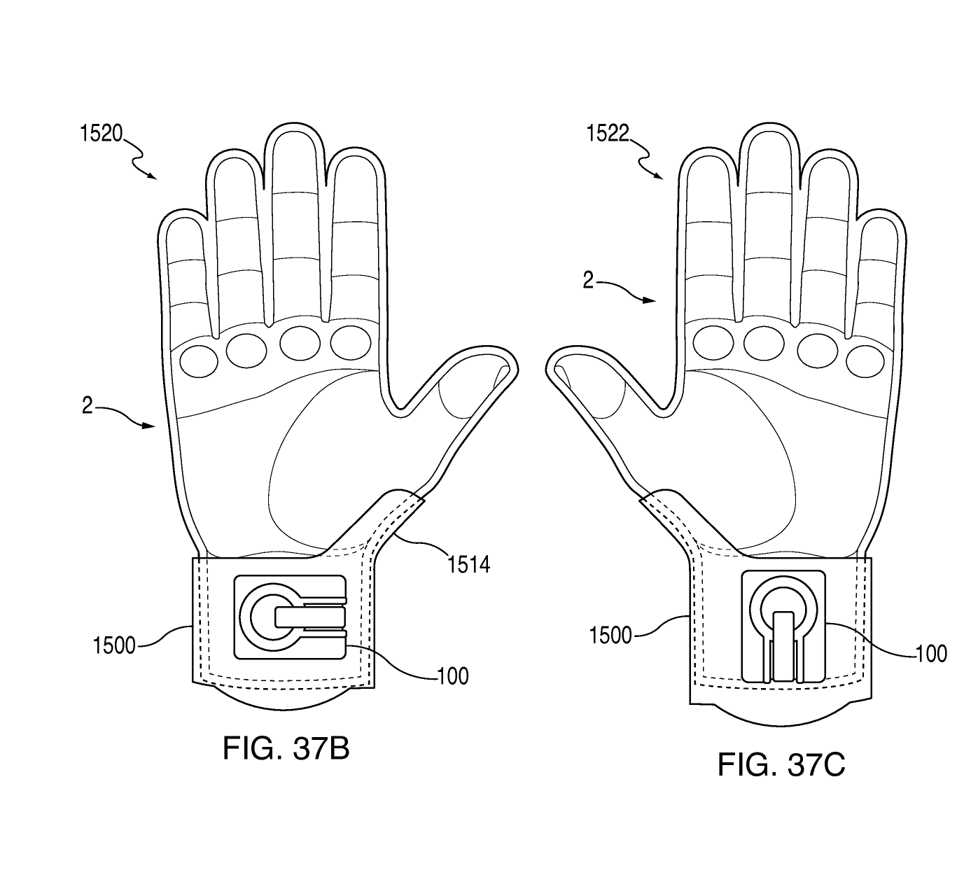

FIG. 36 is an illustrative graph of power versus revolutions per minute (“RPM”) for various micro-generators in accordance with various embodiments. Graph 1400 may correspond to a measurement of total output power, in Watts, from all three phases of the three-phase micro-generator as the RPM is varied. Graph 1400 may include traces 1402, 1404, and 1406. Trace 1402 may correspond to power versus RPM plot for a 6 Watt generator with a 4 Ohm load, trace 1404 may correspond to a power versus RPM plot for a 10 Watt generator with a 12 Ohm load, and trace 1406 may correspond to a power versus RPM plot for a 10 Watt generator with a 10 Ohm load.

For a 7 Watt power output, the corresponding RPM should fall between 2300 and 2600 RPM. Thus, substantially effective heating may also occur using a 7 Watt generator operating at 2400 RPM, with a 20:1 gear ratio, where an actuator arm may be used to crank the generator with a rotational velocity of two rotations per second or 120 RPM.

FIGS. 37A-E are illustrative diagrams of an exemplary insert for use within an article of clothing for a micro-generator housing in accordance with various embodiments. Insert 1500 of FIG. 37A is one exemplary insert, that may be used within an article of clothing to store housing 100, for example, including micro-generator 200 therein. Insert 1500, in some embodiments, may correspond to a chemically cross-linked closed cell polyethylene foam that may be die cut and thermoformed and heat bonded to an elastic fabric layer. However, persons of ordinary skill in the art will recognize that any other suitable material may be used.

Insert 1500 may include body 1502, which may be shaped such that insert 1500 is capable of wrapping around a wrist portion of glove 2 (e.g., see FIGS. 37B-E). In some embodiments, insert 1500 may include ridges 1506, which may enable insert 1500 to form around a curved structure, such as a wrist, or wrist portion of a glove. However, although the aforementioned description is related to use of insert 1500 with a glove, persons of ordinary skill in the art will also recognize that slightly modifications in the shape and size of insert 1500 may be made so that insert 1500 may be included with other articles of clothing (e.g., sock 20, shirt 40, and/or blanket 60).

Insert 1500 includes raised section 1504 which may be where housing 100, or any other housing for a micro-generator, may be placed. For example, cavity section 120 of housing 100 may be placed in cavity opening 1508, and a lower surface of lower housing portion 104 may contact base portion 1512 of insert 1500. In some embodiments, insert 1500 may include one or more openings 1510. Openings 1510 may be used to couple or secure housing 100 to insert 1500 integrated within an article of clothing (e.g., a glove). In one illustrative embodiment, openings 1510 may be aligned with openings 936 of supporting base plate 930 of housing 900. In this particular scenario, one or more screws or other coupling mechanisms may extend through openings 936 in supporting base plate 930 to openings 1510 to couple housing 900 (or any other housing) to insert 1500 and thus, the corresponding article of clothing insert 1500 is integrated into.

FIGS. 37B-E are various embodiments of insert 1500 integrated into glove 2 with housing 100 including a micro-generator stored therein. However, persons of ordinary skill in the art will recognize that any other housing may be used (e.g., housing 150, 300, 500, 600, 700, 800, 850, and/or 900). Configuration 1520, for example, includes insert 1500 having a thumb stabilizer portion 1514 that extends along at least a part of the thumb portion of glove 2. Thumb stabilizer portion 1514 may provide enhanced stabilization for insert 1500, and thus housing 100, when integrated into glove 2. In configuration 1520, housing 100 is oriented horizontally such that a shorter side of housing 100, if housing 100 is substantially rectangular shaped, is aligned with a length of an individual's wrist, while a longer side of housing 100 is aligned with a width of the individual's wrist. Configuration 1522 is substantially similar to configuration 1520 with the exception that the former has the longer side of housing 100 aligned with the length of the individual's wrist, and the shorter side of housing 100 aligned with the width of the individual's wrist.

Configuration 1524 may be substantially similar to configurations 1520 and 1522 with the exception that housing 100 may be oriented at an angle with respect to the individual's wrist. For example, housing 100 may be oriented at a 45-degree angle with respect to the individual's wrist. Furthermore, configuration 1524 may not include thumb stabilization portion 1514, however this is merely exemplary. Configuration 1526 may be substantially similar to configurations 1520, 1522, and/or 1524, with the exception that it may include wrap around strap 1516 may wrap around the wrist portion of glove 2.

While there have been described heated gloves and methods for making the same, it is to be understood that many changes may be made therein without departing from the spirit and scope of the invention. Insubstantial changes from the claimed subject matter as viewed by a person of ordinary skill in the art, now known or later devised or discovered, are expressly contemplated as being equivalently within the scope of the claims. Therefore, obvious substitutions now or later known to one with ordinary skill in the art defined to be within the scope of the defined elements.

The described embodiments of the invention are presented for the purpose or illustration and not of limitation except as described to the claims below.

What is claimed is:

1. A system for providing heat to an individual, the system comprising:
a first wearable article comprising:
a first heating element integrated into the first wearable article; and
a first connector;
a second wearable article comprising:
a second heating element integrated into the second wearable article; and
a second connector; and
a micro-generator that is removably attachable to at least one of the first connector of the first wearable article and the second connector of the second wearable article.

2. The system of claim 1, wherein the micro-generator is operable to provide energy to the first heating element of the first wearable article when connected to the first connector of the first wearable article.

3. The system of claim 1, wherein the micro-generator is operable to provide energy to the second heating element of the second wearable article when connected to the second connector of the second wearable article.

4. The system of claim 1, wherein the first wearable article further comprises:
a pocket.

5. The system of claim 4, wherein the micro-generator is capable of being stored in the pocket of the first wearable article.

6. The system of claim 1, wherein the first wearable article comprises a glove.

7. The system of claim 1, wherein the second wearable article comprises one of:
a glove, a sock, a shoe, a boot, a shirt, a jacket, a hat, a glove, and a blanket.

8. The system of claim 1, wherein the first wearable article further comprises:
a pocket; and
a pocket cover capable of covering the pocket when the micro-generator is removed from the pocket.

9. A housing for a micro-generator, comprising:
a supporting base plate comprising a first opening;
a lower housing portion located substantially on top of a first side of the supporting base plate, the lower housing portion comprising:
a cavity section that is insertable through the first opening; and
a connector port; and
an upper housing portion engaged with and located on top of the lower housing portion, the upper housing portion comprising:
a first section comprising a second opening; and
a second section comprising a first recess and a second recess.

10. The housing of claim 9, wherein the supporting base plate is integrated into a wearable article.

11. The housing of claim 9, wherein the supporting base plate and at least some of the lower housing portion integrated are integrated into the wearable article.

12. The housing of claim 11, wherein the entire lower housing portion and at least some of the upper housing portion are integrated into the wearable article.

13. The housing of claim 9, further comprising:
a base member; and
a rotating arm having a substantially circular portion coupled to the base member and a rail portion extending away from the base member.

14. The housing of claim 13, wherein:
a portion of the base member protrudes through the second opening in the upper housing portion; and
the rotating arm further comprises a foldable tab coupled to the rail portion and has a first portion operable to fold into the first recess and a second portion operable to fold into the second recess.

15. The housing of claim 9, wherein the supporting base plate is integrated into an insert.

16. The housing of claim 15, wherein the insert is integrated into a wearable article of clothing.

17. The housing of claim 9, wherein the connector port of the lower housing portion enables a connector to couple to a micro-generator housed within the lower and upper housing portions.

18. The housing of claim 9, wherein the supporting base plate, the lower housing portion, and the upper housing portion are each substantially rectangular.

19. The housing of claim 9, wherein the lower housing portion further comprises:
a plurality of first connection openings that connect the lower housing portion and the upper housing portion together; and
a plurality of second connection openings that connect the lower housing portion and the supporting base plate together.

20. The housing of claim 9, wherein the supporting base plate is integrated into a wrist portion of a glove.

21. A manually heatable blanket, comprising:
a blanket comprising a material;
a plurality of heating elements integrated into the material of the blanket; and
a micro-generator coupled to a portion of the blanket and operable to heat the blanket using energy produced by the micro-generator.
